(19) United States
(12) Patent Application Publication
(10) Pub. No.: US 2002/0046311 A1
(43) Pub. Date: Apr. 18, 2002

(54) Communications controlling method, communications system, and communications device

(76) Inventor: Yuichi Kageyama, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/921,798

(22) Filed: Aug. 3, 2001

(30) Foreign Application Priority Data
Aug. 4, 2000 (JP) 2000-237453

(51) Int. Cl. G06F 13/42

(52) U.S. Cl. 710/105

(57) ABSTRACT

An object of the present invention is to avoid problems in the network provided e.g. by the IEEE 1394, associated with making a notice following a request from a particular device.

A first communications device sends a first command to a second communications device in the network, thereby giving instruction for notifying to the first communications device on a predefined status change performed under control of the second communications device. Then, the second communications device notifies to the first communications device on the predefined status change only if the status change has taken place within a predetermined time period measured from a time of reception of the first command, and the notice is not made after the time period.

### BACKGROUND OF THE INVENTION

1. Field of the Invention

The present invention relates to a communications controlling method and a communications system suitably applied to data transmission between devices interconnected e.g. via an IEEE 1394 bus line. The present invention also relates to a communications device that uses the above method.

2. Description of the Related Art Audio devices and video devices (hereinafter called the AV devices) capable of mutually transmitting information via a network provided by IEEE 1394 serial data bus have been developed. When the data transmission is made via this data bus, two modes of transmission are available, i.e. isochronous transmission mode for real-time data transmission of relatively large amount of data such as animation data, audio data and so on, and asynchronous transmission mode for more reliable transmission of still image data, text data, control commands and so on. For each of the modes, a dedicated bandwidth is allocated so that the two modes can be used simultaneously in the data transmission on a single bus.

According to this network, the AV device can be remote-controlled by using predefined commands (AV/C Command Transaction Set, hereinafter called the AV/C commands). Details of the IEEE 1394 and the AV/C commands are disclosed in AV/C Digital Interface Command Set General Specification released by the 1394 Trade Association.

The AV/C command set used between the devices interconnected via the IEEE 1393 bus line not only allow sending a control command thereby controlling a target device, but also allows sending a status command for inquiring the target device of its status as well as sending a “notify” command (notice-requesting command) which is a command requesting the target device to send a notice upon a predefined status change. Further, the command set allows the devices to perform operations based on these commands. The following example shows how the notify command may be used: Specifically, if there is no available channels on the bus line, the notify command may be sent to the device that is currently using the channel, thereby having the occupying device notify when the channel has become available. More examples of these commands will be explained in detail later, when embodiments of the present invention are described.

Now, there is a problem when using the notify command or which is requesting a counterpart device in a network to send a notice on a certain predefined status change. Specifically, the target device which has received the notify command does not know when the specified status change will take place, and therefore must remember the requesting device as a cue. Since there is a limitation to a memory area for storing the cue, if all of the area is already filled, a newly arrived “notify” command is rejected.

For example, if the target device can only store one cue, and the target device has received a notify command but the status change specified by the notify command would not take place, the target device can no longer receive any other notify commands from elsewhere for a prolonged period of time. This creates a situation in which command-based operations provided in the network are not executable as intended. In such a case, the cue will stay in the memory until a bus reset takes place. The bus reset takes place when there is a change in hardware configuration in the network. Unless the bus reset takes place, the target device can no longer receive a new notify command.

There is another problem. Specifically, the network provided by the IEEE 1394 bus line can include a plurality of networks interconnected by means of bus bridge. However, bus reset information is not transmitted to devices interconnected via the bus bridge. Thus, if the notify command is used via a plurality of networks connected by the bus bridge, there is no such opportunity as that the bus reset will eventually resolve the problem.

For example, assume that a device (controlling device) in one network issues a notify command to another device (target device) in another network. The instruction by the command is now stored as a cue in the target device. If the controlling device, which is the issuer of the notify command, is then disconnected from the network it belongs to, a bus reset takes place in this particular network. However, no bus reset takes place in the other network to which the target device, which stores the cue, belongs. The result is that the target device is left with a useless cue.

On the other hand, if a bus reset takes place in the network to which the target device belongs, the cue in the memory becomes void, yet the controlling device continues to wait for the notice to be issued on the basis of the notify command.

FIG. 1 shows an example of how a notify command may be used. In this example, there are three controllers a, b, c and a target device in a network. The target device, which accepts notify commands from any of the controllers, can store up to two cues, i.e. two notify commands. Now, the controller a transmits to the target device a notify command requesting a notice on a status change in relation to a certain operation X (Step S81). Upon reception of this notify command, the target device stores the node ID of the controller a in one of the two memory areas for the cues relevant to the operation X. The target device then issues an interim response (Step S82) to the controller a, confirming the reception of the notify command.

Then, assume further that the controller b also transmits to the target device another of the notify command requesting a notice on the status change in relation to the operation X (Step S83). Upon reception of this notify command, the target device stores the node ID of the controller b in the remaining one memory area for the cues relevant to the operation X. The target device then issues an interim response (Step S84) to the controller b, confirming the reception of the notify command.

Then, assume further that the controller c also transmits to the target device another of the notify command requesting a notice on the status change in relation to the operation X (Step S85). Upon reception of this notify command, the target device, which no longer has available memory area for the cue relevant to the operation X, then issues a rejection response (Step S86) to the controller c, informing that the notify command is rejected.

With the above situation, once the status change relevant to the operation X takes place under the control of the target device, the target device sends to the controllers a and b a “changed” response (Step S87, S88), informing that the status change has taken place, and erase the node IDs stored in the cues.

As has been exemplified in the above example, it is a problem that the target device cannot receive a new notify command if there is no longer memory area available for the cue.

FIG. 2 shows another example of operation. In this example, controllers a and b, and a target device are in a first network, but a controller c is in a second network interconnected with the first one via a bus bridge. With this configuration, first, the controller a transmits to the target device a notify command requesting a notice on a status change in relation to a certain operation X (Step S91). Upon reception of this notify command, the target device stores the node ID of the controller a in one of the two memory areas for the cues relevant to the operation X. The target device then issues an interim response (Step S92) to the controller a, confirming the reception of the notify command.

Then, assume further that the controller c also transmits to the target device another of the notify command (Step S93) requesting a notice on the status change in relation to the operation X. Upon reception of this notify command, the target device stores the node ID of the controller c in the remaining one memory area for the cues relevant to the operation X. The target device then issues an interim response (Step S94) to the controller c, confirming the reception of the notify command.

Then, assume that the controller c is disconnected from the bus. The disconnection causes a bus reset to take place in the network to which the controller c belonged. However, no bus reset takes place in the other network to which the target device is connected. As a result, the node ID of the controller c remain in the cue memory area of the target device.

With the above situation, assume that the controller b transmits to the target device another of the notify command requesting a notice on the status change in relation to the operation X (Step S95). Upon reception of this notify command, the target device, which no longer has available memory area for the cue relevant to the operation X, issues a rejection response (Step S96) to the controller b, informing that the notify command is rejected. In reality however, the controller c is already disconnected from the network, yet the memory of the unnecessary data in the cue causes the rejection to the notify command in Steps S95 and S96.

The cue memory area of the target device will not be initialized again until, for example, the controller b is disconnected from the network to trigger a bus reset. When this bus reset takes place, the controller a resend the notify command (Step S97) to the target device for example, in order to restore the cue memory about the controller a. As has been exemplified above, there is a problem that initialization by a bus reset is not effective to a notify command transmitted from a device in another network connected via a bus bridge.

It should be noted here that the above-described problems associated with the use of notify command is not peculiar to a network interconnected via the IEEE 1394 bus line but common to other networks of different communications configurations, when the notice operation is performed.

An object of the present invention is to avoid these problems in the network provided by e.g. the IEEE 1394 bus line, associated with making a notice following a request from a particular device.

### SUMMARY OF THE INVENTION

The present invention provides a method for controlling communications, in a network capable of allowing a plurality of communications devices to perform mutual data communication. In this method, a first communications device sends a first command to a second communications device in the network, thereby giving instruction for notifying to the first communications device on a predefined status change performed under control of the second communications device. Then, the second communications device notifies to the first communications device on the predefined status change only if the status change has taken place within a predetermined time period measured from a time of reception of the first command, and the notice is not made after the time period.

According to this invention, the first command sent from the first device for execution of the notice is only valid for a predetermined period of time. Upon elapse of the time, the instruction by the first command becomes void.

According to the invention disclosed in a first aspect, the first command sent from the first communications device for execution of the notice is only valid for a predetermined period of time. After this time has passed, the instruction given by the first command becomes void. By appropriately setting the time period for which the command is valid, administrative operation performed in the second communications device, such as data storage for making the notice, can be performed appropriately, making it possible to effectively avoid such a situation as inability to make a notice appropriately in the network due to undeleted data which is stored once for the notice but unnecessarily remaining in the second communications device.

The invention disclosed in a second aspect, is the invention disclosed in the first aspect, wherein the second communications device transmits to the first communications device information about the predetermined time period as a response, upon reception of the first command. This allows the first communications device to reliably discern how long the current command is valid.

The invention disclosed in a third aspect, is the invention disclosed in the first aspect, wherein the second communications device transmits to a third communications device, upon reception from the third communications device of a second command including instruction for notifying on the predefined status change, information about the predetermined time period as a response to the second command, if the second communications device is unable to notify to the third communications device on the predefined status change. With this arrangement, the third communications device, which issued the second command rejected, can discern from the time information included in the response, when the second command will be accepted. Thus, the third communications device can resend the second command after the predicted time has elapsed for example, thereby making sure that the instruction based on the second command will be performed.

The invention disclosed in a fourth aspect, is the invention disclosed in the first aspect, wherein the second communications device transmits to the first communications device, information indicating that a timeout has reached, upon elapse of the predetermined time period measured from the time of reception of the first command. With this arrangement, the first communications device can discern for sure that the first command has been voided, and thus can take such an action as resending the first command for example.

The invention disclosed in a fifth aspect, is the invention disclosed in the fourth aspect, wherein the second communications device also transmits to the first communications device, information indicating that a timeout has reached, before the elapse of the predetermined time period measured from the time of reception of the first command, if the second communications device becomes unable to notify on the predefined status change. With this arrangement, if the second communications device has its power supply turned off for example, and becomes unable to notify the status change, the first communications device can discern the situation.

The method of controlling communication disclosed in a sixth aspect, is the invention disclosed in the first aspect, wherein the predefined status change is a status change in use of a bandwidth or a channel controlled by the second communications device. Therefore, the first communications device for example can be quickly informed when a desired bandwidth or channel has become available.

The method of controlling communication disclosed in a seventh aspect, is the invention disclosed in the first aspect, wherein the first communications device sends to the second communications device a command that extends the predetermined time period, before or after the elapse of the predetermined time. With this arrangement, even if the notice-requesting command is valid only for a certain predetermined time, by sending the extension-requesting command, the effective period of the notice-requesting command can be extended virtually arbitrarily.

According to the communications system disclosed in an eighth aspect, the first command sent from the first communications device for execution of the notice is only valid for a predetermined period of time. After this time has passed, the instruction given by the first command becomes void. By appropriately setting the time period for which the command is valid, administrative operation performed in the second communications device, such as data storage for making the notice, can be performed appropriately, making it possible to effectively avoid such a situation as inability to make a notice appropriately in the network due to undeleted data which is stored once for the notice but unnecessarily remaining in the second communications device.

The communications system disclosed in a ninth aspect is the invention disclosed in the eighth aspect, wherein the second communications device further includes a response generating means which generates a response including information about the predetermined time period, upon reception of the command by the second communications means, the second communications device transmitting the response generated by the response generating means from the second communications means to the first communications device. This allows the first communications device to reliably discern from the information included in the response how long the current command is valid.

The communications system disclosed in a tenth aspect is the invention disclosed in the ninth aspect, wherein the response generating means generates a response including the information about the predetermined time period and informing of inability to issue the notice, if the second communications means receives another of the command including instruction for notifying the predefined status change, from another of the communications devices, after the transmission of the response to the first communications device but before elapse of the predetermined time period. With this arrangement, the communications device whose command is rejected can discern from the time information included in the response, when the command will be accepted. Thus, the communications device can resend the command after the predicted time has passed for example, thereby making sure that the instruction based on the command will be performed.

The communications system disclosed in an eleventh aspect is the invention disclosed in the eighth aspect, wherein the second communications device sends to the first communications device, information indicating that a timeout has reached, upon discerning by the second controlling means of elapse of the predetermined time period. With this arrangement, the first communications device can discern for sure that the first; command has been voided, and thus can resend the first command for example.

The communications system disclosed in a twelfth aspect is tile invention disclosed in the eleventh aspect, wherein the second controlling means sends from the second communications means to the first communications device, information indicating that a timeout has reached, also upon discerning of a situation which disables to notify the first communications device on the predefined status change before the elapse of the predetermined time period. With this arrangement, if the second communications device has its power supply turned off for example, and becomes unable to notify the status change, the first communications device can discern the situation.

The communications system disclosed in a thirteenth aspect is the invention disclosed in the eighth aspect, wherein the predefined status change discerned by the second controlling means of the second communications device is a status change in use of a bandwidth or a channel controlled by the second communications device. Therefore, the first communications device for example can be quickly informed when a certain bandwidth or channel becomes available.

The communications system disclosed in a fourteen aspect is the invention disclosed in the eighth aspect, wherein the first controlling means of the first communications device has the command generating means generate the second command for extending the predetermined time period, and sends this command from the first communications means to the second communications device, before or after the elapse of the predetermined time. With this arrangement, even if the notice-requesting command is valid only for a certain predetermined time, by sending the extension-requesting command, the effective period of the notice-requesting command can be extended virtually arbitrarily.

According to the communications device disclosed in a fifteenth aspect, if there is a need for notifying a predefined status change based on a command received by the device, the notice is made only for a predetermined period of time measured from a time of reception of the command. With this arrangement, it becomes possible for example to place a limit on duration of storage time for data necessary to make the notice on the predefined status change. This makes it possible to effectively avoid such a situation as inability of the other devices in the network to send a command, due to undeleted data which is stored once for the notice but unnecessarily remaining in the communications device.

The communications device disclosed in a sixteenth aspect is the invention disclosed in the fifteenth aspect, wherein the device further comprises a response generating means which generates a response including information about the predetermined time period, upon reception of the command by the communications means, the communications means transmitting the response generated by the response generating means to the other communications device. With this arrangement, the communications device that has sent the command and received the response can reliably discern how long the current command is valid.

The communications device disclosed in a seventeenth aspect is the invention disclosed in the sixteenth aspect, wherein the response generating means generates and transmits from the communications means a response including the information about the predetermined time period and informing of inability to issue the notice, if the communications means receives from still another of the communications device still another of the command including instruction for notifying the predefined status change, after the transmission of the response to the other communications device but before elapse of the predetermined time period with this arrangement, the communications device which receives the response can discern when the command will be accepted, based on the time information included in the response. Thus, this communications device can resend the command after the predicted time has elapsed for example, thereby making sure that the instruction based on the second command will be performed.

The communications device disclosed in an eighteenth aspect is the invention disclosed in the fifteenth aspect, wherein the communications means sends to the other communications device information indicating that a timeout has reached, upon discerning by the controlling means of elapse of the predetermined time period. With this arrangement, the command-sender device can discern for sure that the command has been voided, and thus can take such an action as resending the first command for example.

The communications device disclosed in a nineteenth aspect is the invention disclosed in the eighteenth aspect, wherein the controlling means sends from the communications means to the other communications device, information indicating that a timeout has reached, also upon discerning of a situation which disables to notify the other communications device on the predefined status change before the elapse of the predetermined time period. With this arrangement, if the communications device that has received the command has its power supply turned off for example, and becomes unable to notify the status change, the other communications device can discern the situation.

The communications device disclosed in a twentieth aspect is the invention disclosed in the fifteenth aspect, wherein the predefined status change discerned by the controlling means is a status change in use of a bandwidth or a channel on the network. Therefore, when a bandwidth or channel controlled by this communications device becomes available for example, the availability can be quickly informed to the counterpart device.

According to the communications device disclosed in a twenty-first aspect, the device that has sent the command can resend the command based on a predicted time for which the command that has sent remains effective. Therefore, even if the command can be effective for a limited period of time, it becomes possible to have the command continue to be effective for execution by the counterpart device.

### BRIEF DESCRIPTION OF THE DRAWINGS

FIG. 1 is a timing chart showing a transmission example (Example 1) of a NOTIFY command;

FIG. 2 is a timing chart showing a transmission example (Example 2) of a NOTIFY command;

FIG. 3 is diagram showing a network configuration example according to an embodiment of the present invention;

FIG. 4 is a block diagram showing a device configuration example (of an IRD) in the network according to the embodiment of the present invention;

FIG. 5 is a block diagram showing a device configuration example (of a television receiver) in the network according to the embodiment of the present invention;

FIG. 6 is a block diagram showing a device configuration example (of a video recorder/player) in the network according to the embodiment of the present invention;

FIG. 7 is a block diagram showing a device configuration example (of an audio recorder/player) in the network according to the embodiment of the present invention;

FIG. 8 is a block diagram showing a device configuration example (of an audio player) in the network according to the embodiment of the present invention;

FIG. 9 is a diagram showing an example of data transmission cycle structure on an IEEE 1394 bus;

FIG. 10 is a diagram showing an example of address space structure in CRS architecture;

FIG. 11 is a table showing examples of typical CRS locations, names and functions;

FIG. 12 is a chart showing an example of general ROM format;

FIG. 13 is a chart showing an example of a bus info block, a root directory and a unit directory;

FIG. 14 is a chart showing an example of a PCR structure;

FIG. 15 is a chart showing a structure example of oMPR, oPCR, iMPR and iPCR;

FIG. 16 is a chart showing an example relationship among plugs, plug control registers and transmission channels;

FIG. 17 is a chart showing data structure example according to descriptor hierarchical structure;

FIG. 18 is a chart showing data format example of a descriptor;

FIG. 19 is a chart showing an example of a generation ID in FIG. 18;

FIG. 20 is a chart showing an example of a list ID in FIG. 18;

FIG. 21 is a chart showing a stack model example of an AV/C command;

FIG. 22 is a chart showing a relationship between an FCP command and a response;

FIG. 23 is a chart showing a more detailed relationship between the command and the response in FIG. 22;

FIG. 24 is a chart showing a data structure example of an AV/C command;

FIG. 25 is a chart showing a specific example of an AV/C command;

FIG. 26 is a chart showing a specific example of an AV/C command and a response;

FIG. 27 is a flowchart showing a process when receiving a NOTIFY command, according to an embodiment of the present invention;

FIG. 28 is a chart showing a format example of a NOTIFY command according to the embodiment of the present invention;

FIG. 29 is a chart showing a format example of a response according to the embodiment of the present invention;

FIG. 30 is a timing chart showing a transmission example according to the embodiment of the present invention;

FIG. 31 is a flowchart showing a process when receiving a NOTIFY command, according to another embodiment of the present invention;

FIG. 32 is a timing chart showing a transmission example according to the embodiment in FIG. 31;

FIG. 33 is a chart showing examples of a command and a response according to still another embodiment of the present invention; and

FIG. 34 is a timing chart showing a transmission example of the command and the response in FIG. 33.

### DETAILED DESCRIPTION OF THE PREFERRED EMBODIMENT

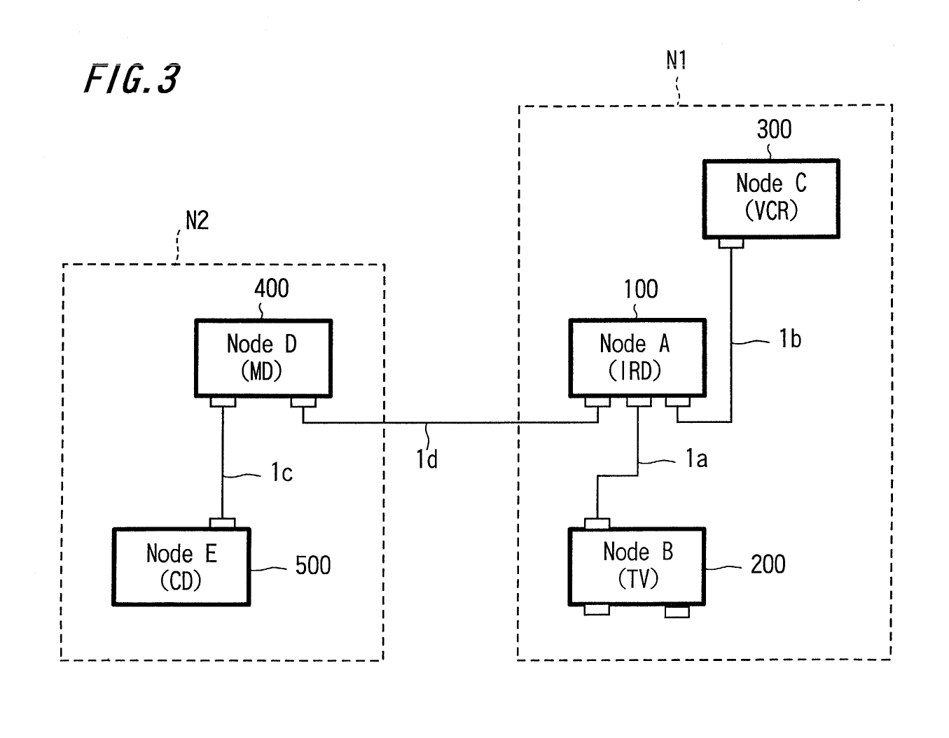

Hereinafter, embodiments of the present invention will be described with reference to FIG. 3 through FIG. 30.

FIG. 3 shows an example of a network configuration according to the embodiment of the present invention. In this embodiment, bus lines 1a, 1b, 1c, 1d based on the IEEE 1394 standards provide a network interconnecting a plurality of AV devices. More specifically, in this embodiment, the AV devices includes an IRD (integrated Receiver Decoder: digital satellite broadcasting receiver) 100, a television receiver 200, a video recorder/player 300, an audio recorder/player 400, and an audio player 500. Each of the devices 100 through 500 has an IEEE 1394 bus line port. The ports are connected sequentially by means of the bus lines 1a, 1b, 1c and 1d.

In this particular embodiment, a first network N1 includes three devices, i.e. the IRD 100, the TV receiver 200 and the video recorder/player 300, whereas a second network N2 includes the audio recorder/player 400 and the audio player 500. The first network N1 and the second network N2 are connected with each other by the bus line 1d. The bus line id represents a bus bridge interconnecting the two networks.

Each of the devices interconnected by the bus lines 1a through 1d are called “unit” in the AV/C command terminology. By using commands specified in the AV/C commands, each of the interconnected units can read and write information in other units. Each unit has its individual functions, which are called sub units.

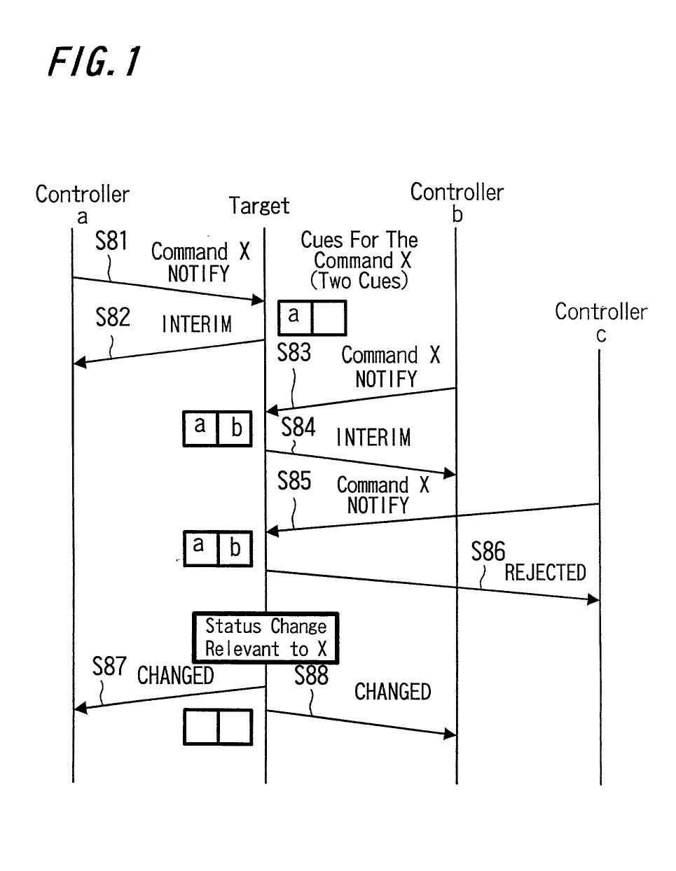

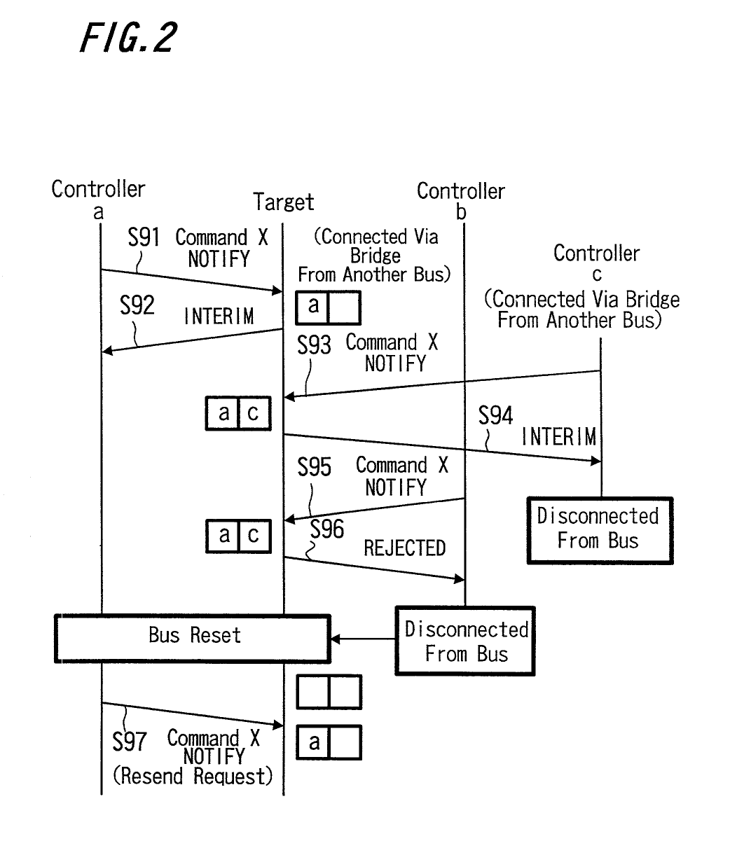

Further, each of the units is also called “node.” In this embodiment, the nodes are identified by the following node IDs: Specifically, the IRD 100 is called node A, the television receiver 200 is called node B, the video recorder/player 300 is called node C, the audio recorder/player 400 is called node D, and the audio player 500 is called node E. Note should be made here that these node IDs will be reassigned upon bus reset, and therefore the units may then have different node IDs. Note should be made further, that in practical application, the node ID is assigned on the network basis, and in a case where a plurality of networks are interconnected via bus bridge as shown in FIG. 1, each unit is identified by a combination of the node ID and a network ID.

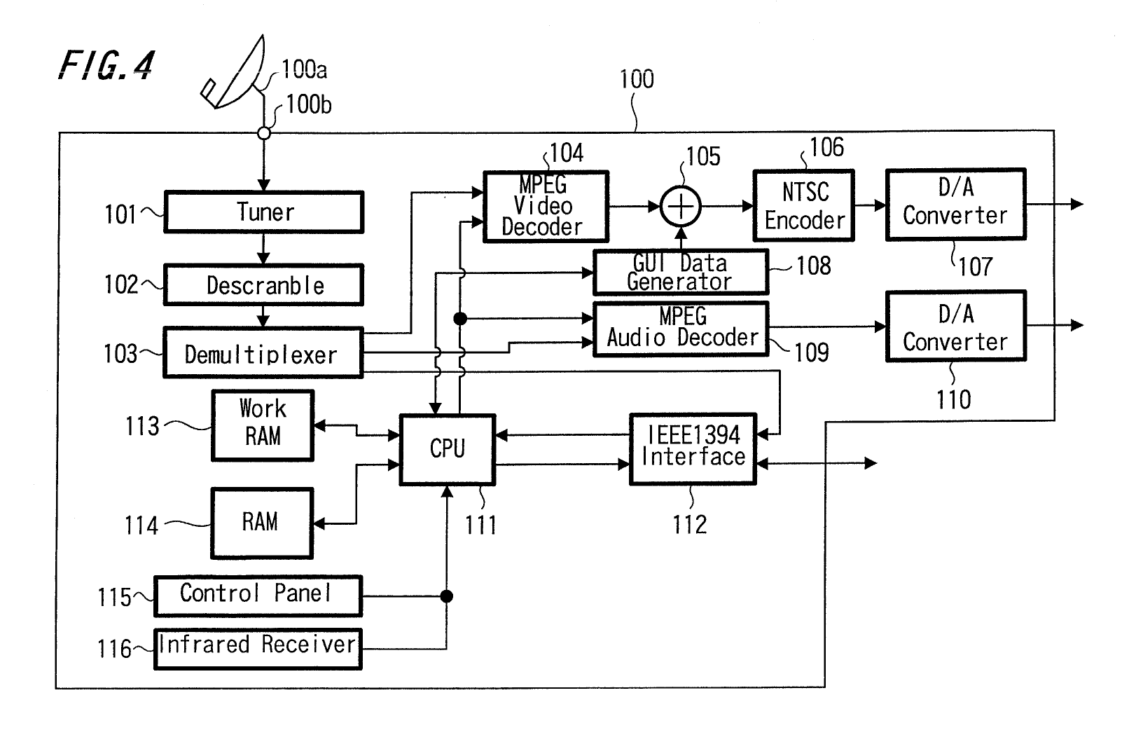

FIG. 4 shows a specific configuration of the IRD 100. Broadcast waves from satellites are received by an antenna 100a, inputted to a terminal 100b and then to a tuner 101 serving as program selecting means provided in the digital satellite broadcast receiver 100. The IRD 100 has all its circuits controlled by a central processing unit (CPU) 111. Signals from predetermined channels are received by the tuner 101. The signals received by the tuner 101 are supplied to a descramble circuit 102.

The descramble circuit 102 makes reference to an IC card (not illustrated) inserted into the IRD 100, checks encrypted key information on subscribed channels stored in the card, and based on this information, picks up only multiplex data from the subscribed channels (or data which is not encrypted), and then supplies the data to the demultiplexer 103.

The demultiplexer 103 rearrange the supplied multiplex data in the order of the channels, picks up the data of the channel selected by the user, sends a video stream that contains image packets to the MPEG video decoder 104, and sends an overlap stream that contains audio packets to the MPEG audio decoder 109.

The MPEG video decoder 104 decodes the video stream thereby restoring image data as before compression encryption, and sends the restored data to an NTSC encoder 106 via an adder 105. The NTSC encoder 106 converts the image data into NTSC luminance signals and color difference signals, and sends the converted signals to a digital/analog converter 107 as NTSC video data. The digital/analog converter 107 converts the NTSC data into analog video signals, and sends the converted data to an image display connected thereto. Note that FIG. 3 does not show signal lines for transmitting the analog video signals, but the television receiver 200 can serve as the image display.

The IRD 100 according to the present embodiment includes a graphical user interface (GUI) data generator 108 which generates various image data to be displayed for a GUI interface, based on the control provided by the CPU 111. The image data (display data) for the GUI, generated by the GUI data generator 108, is supplied to the adder 105 and superimposed to the image data from the MPEG video decoder 104, so that the image for the GUI is displayed as superimposition in the broadcast image.

The MPEG audio decoder 109 decodes the audio stream thereby restoring PCM audio data as before compression encryption, and sends the restored data to an digital/analog converter 110.

The digital/analog converter 110 converts the PCM audio data into analog signal thereby generating L ch audio signal and R ch audio signal, and sends these signals to speakers (not illustrated) of the audio player system for sound output.

Further, in the IRD 100 according to the present embodiment, the video stream and the audio stream extracted by the demultiplexer 103 can be supplied to an IEEE 1394 interface 112 so that the streams can be sent out to the IEEE 1394 bus line which is connected to the interface 112. The received video stream and the audio stream are transmitted in isochronous transmission mode. Also, if the GUI data generator 108 generates image data for the GUI, this image data can be supplied to the interface 112 via the CPU 111, so that the GUI image data can be transmitted through the bus line from the interface 112.

The CPU 111 is connected with a work RAM 113 and a RAM 114. These memories are utilized for various control operations. Further, the CPU 111 is supplied with operation information from a control panel 115 and remote control signals from an infrared receiver 116, so that the control operations can be initiated by various user inputs. Still further, the CPU 111 can make decisions on commands, responses and so on transmitted from the bus line to the interface 112.

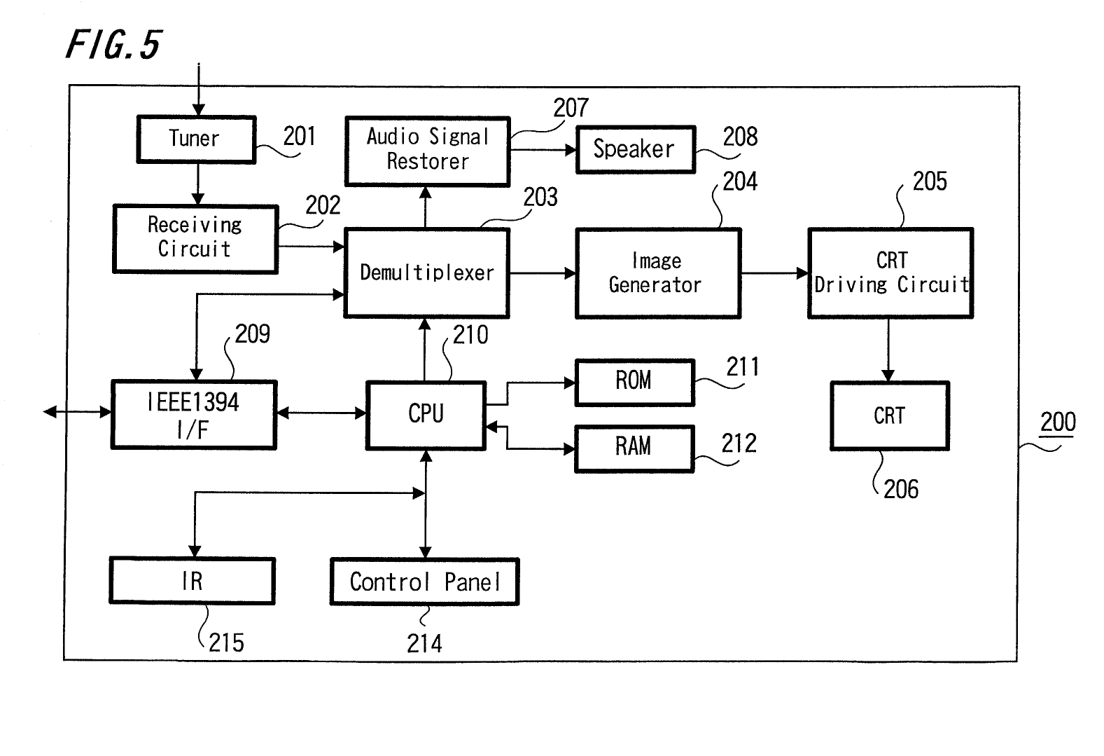

FIG. 5 is a block diagram showing a configuration of the television receiver 200. The television receiver 200 according to the present embodiment is a so-called digital television receiver, which receives and displays digital broadcast.

An unillustrated antenna is connected with a tuner 201, where digital broadcast data of a selected channel is received. The received data is supplied to and decoded by a receiving circuit 202. The decoded broadcast data is then supplied to a demultiplexer 203, where the data is separated into image data and audio data. The separated image data is supplied to an image generator 204, where processing necessary for display is performed. The processed signal is then supplied to a CRT driving circuit 205 to drive a cathode ray tube (CRT) 206 thereby displaying the image. On the other hand, the separated audio data is supplied to an audio signal restorer 207, where necessary audio processing such as analog conversion and amplification are performed. The processed audio signal is supplied to a speaker 208 for output.

The television receiver 200 further includes an interface 209 for connection with the IEEE 1394 bus line, so that image data and audio data supplied from the IEEE 1394 bus line to the interface 209 can be supplied to the demultiplexer 203 for image display on the CRT 206 and audio output from the speaker 208. Still further, image data and audio data received by the tuner 201 can be supplied from the demultiplexer 203 to the interface 209, so that these data can be transmitted through the IEEE 1394 bus.

The above display operation in the television receiver 200 and the transmission operation via the interface 209 in the television receiver 200 are controlled by a central processing unit (CPU) 210. The CPU 210 is connected with a memory 211 which is a ROM that stores programs and other information necessary for the control. The CPU is also connected with a memory 212 which is a work RAM. Further, the CPU 210 is supplied with operation information from a control panel 214 and control information from a remote controller received by an infrared receiver 215, so that the control operations are made in accordance with such operation information and control information. Still further, when the interface 209 receives control data such as an AV/C command via the IEEE 1394 bus, the received data is supplied to the CPU 210, and the CPU 210 makes responsive control operation.

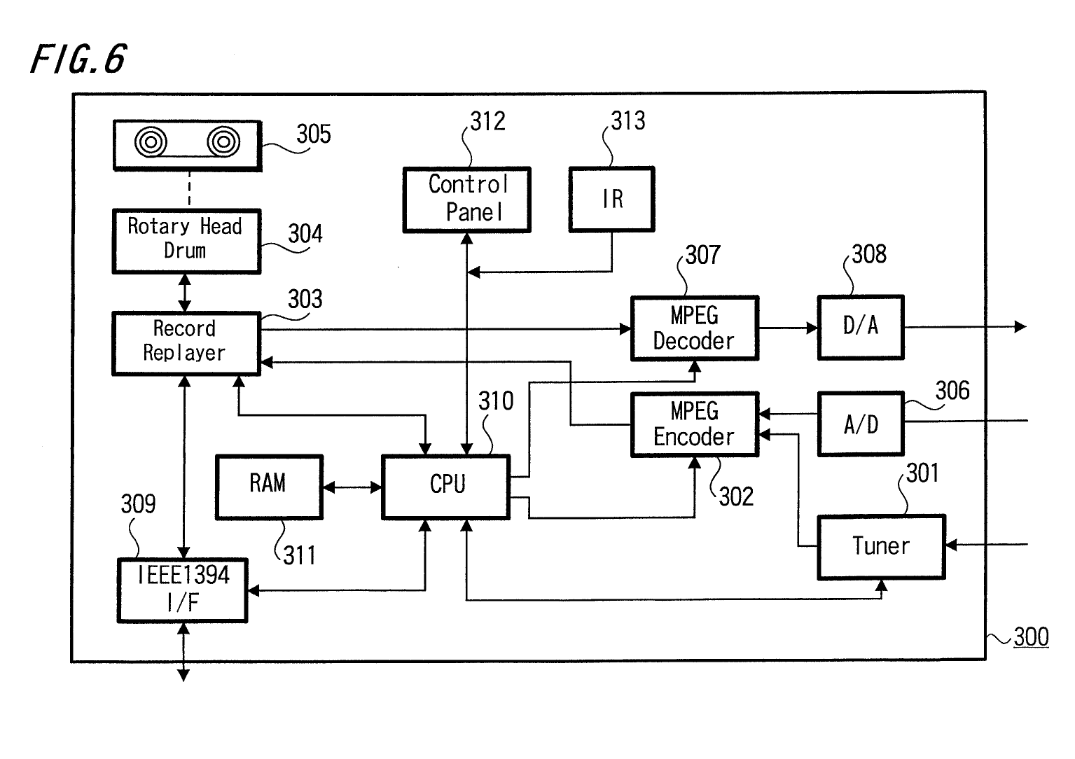

FIG. 6 is a block diagram showing a specific configuration of the video recorder/player 300.

First, recording system will be described. Digital broadcast data from a selected channel received by a tuner 301 incorporated in the video recorder/player 300 is supplied to an MPEG (Moving Picture Experts Group) encoder 302 for conversion to a format suitable for recording. For example, the data is converted to image data and audio data of MPEG 2 format. If the received data is already of the MPEG 2 format, the process in the encoder is not performed.

The data encoded by the MPEG encoder 302 is then supplied to a record replayer 303, where processing necessary for the recording is performed. The processed record data is then supplied to a recording head incorporated in a rotary head drum 304, for recording in a magnetic tape encased in a tape cassette 305.

Analog image signal and audio signal inputted from external device are first converted into digital data by an analog/digital converter 306, and then supplied to the MPEG encoder 302 for conversion to image and audio data of the MPEG 2 format for example. The encoded data is then supplied to the record replayer 303 for the processing necessary for the recording. The processed record data is then supplied to the recording head incorporated in a rotary head drum 304, for recording in a magnetic tape encased in a tape cassette 305.

Now, the playing system will be described. A magnetic tape encased in a tape cassette 305 is played back by the rotary head drum 304. Obtained signal is then processed by the record replayer 303 to obtain image data and audio data. The obtained image data and audio data are supplied to an MPEG decoder 307, where decoding from the MPEG 2 format for example is performed. The decoded data are the supplied to a digital/analog converter 308 to obtain analog image signal and audio signal for output.

The video recorder/player 300 further includes an interface 309 for connection with the IEEE 1394 bus line, so that image data and audio data supplied from the IEEE 1394 bus line to the interface 309 can be supplied to the record replayer 303 for recording in a magnetic tape encased in a tape cassette 305. Still further, image data and audio data played back from a magnetic tape encased in a tape cassette 305 can be supplied from the record replayer 303 to the interface 309, so that these data can be transmitted through the IEEE 1394 bus line.

In this transmission via the interface 309, there can be a case where the recording format (the MPEG 2 format for example) used when recording into a medium (magnetic tape) in the video recorder/player 300 differs from a format used when transmitting through the IEEE 1394 bus. In such a case, format conversion may be performed by using a circuit provided in the video recorder/player 300.

The above recording operation, playback operation, and transmission operation via the interface 309, in the video recorder/player 300 are controlled by a central processing unit (CPU) 310. The CPU 310 is connected with a memory 311 which is a work RAM. Further, the CPU 310 is supplied with operation information from a control panel 312 and control information from a remote controller received by an infrared receiver 313, so that the control operations are made in accordance with such operation information and control information. Still further, when the interface 309 receives control data such as an AV/C command via the IEEE 1394 bus, the received data is supplied to the CPU 310, and the CPU 310 makes responsive control operation.

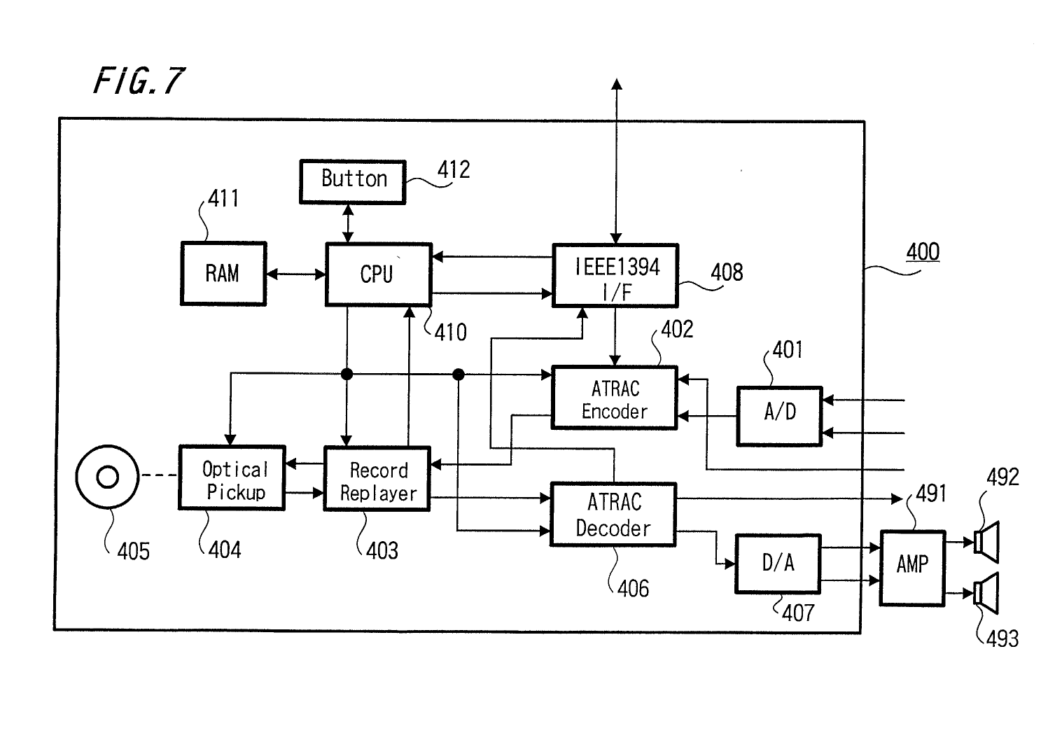

FIG. 7 is a block diagram showing a configuration of an audio recorder/player 400. The audio recorder/player 400 according to the present embodiment records and plays audio signal for example in the form of digital data, by using a so-called MD (minidisk) as a recording medium. The minidisk is a magneto-optical disc or an optical disc encased in a resin package.

First, recording system will be described. Two-channel, analog audio signal inputted from outside is converted to digital audio data by an analog/digital converter 401. The converted digital audio data is supplied to an ATRAC (Adaptive Transform Acoustic Coding) encoder 402 for conversion to an audio data compressed in accordance with ATRAC format. If the input from outside is a digital audio data, the inputted audio data is supplied directly to the ATRAC encoder 402, without the interception by the analog/digital converter 401. The data encoded by the encoder 402 is then supplied to a record replayer 403, where processing necessary for the recording is performed. The processed record data is then used to drive an optical pickup 404 thereby recording the data in a disc (magneto-optical disc) 405. At the time of recording, magnetic modulation is performed by an unillustrated magnetic head.

Now, playing system will be described. Data recorded in a disc (magneto-optical disc or optical disc) 405 is read out by the optical pickup 404, and then processed by the record replayer 403 for the playback, to obtain compressed audio data in the ATRAC format. This audio playback data is supplied to an ATRAC decoder 406 for decoding into digital audio data of a predetermined format. The decoded audio data is supplied to a digital/analog converter 407, where the data is converted into analog, two-channel audio signal for output. If the digital audio data is to be outputted directly to an external device, the audio data as decoded by the ATRAC decoder 406 is directly outputted, without interception by the digital/analog converter 407. Note that according to the embodiment shown in FIG. 7, the analog audio output signal as converted is first supplied to an amplifier 491, where amplification and other processing necessary for the audio output are performed, and then to speakers 492, 493 for two-channel sound (audio) output.

The audio recorder/player 400 further includes an interface 408 for connection with the IEEE 1394 bus line, so that audio data supplied from the IEEE 1394 bus line to the interface 408 can be supplied to the record replayer 403 via the ATRAC encoder 402, for recording in a disc 405. Still further, audio data played back from a disc 405 can be supplied to the interface 408 via the ATRAC decoder 406 from a record replayer 403, so that the data can be transmitted through the IEEE 1394 bus line.

The above recording operation and playback operation, and transmission operation via the interface 408, performed in the audio recorder/player 400 are controlled by a central processing unit (CPU) 410. The CPU 410 is connected with a memory 411 which is a work RAM. Further, the CPU 410 is supplied with operation information from a control panel 412, so that the control operations are made in accordance with such operation information. Still further, when the interface 408 receives control data such as an AV/C command via the IEEE 1394 bus line, the received data is supplied to the CPU 410, and the CPU 410 makes responsive control operation.

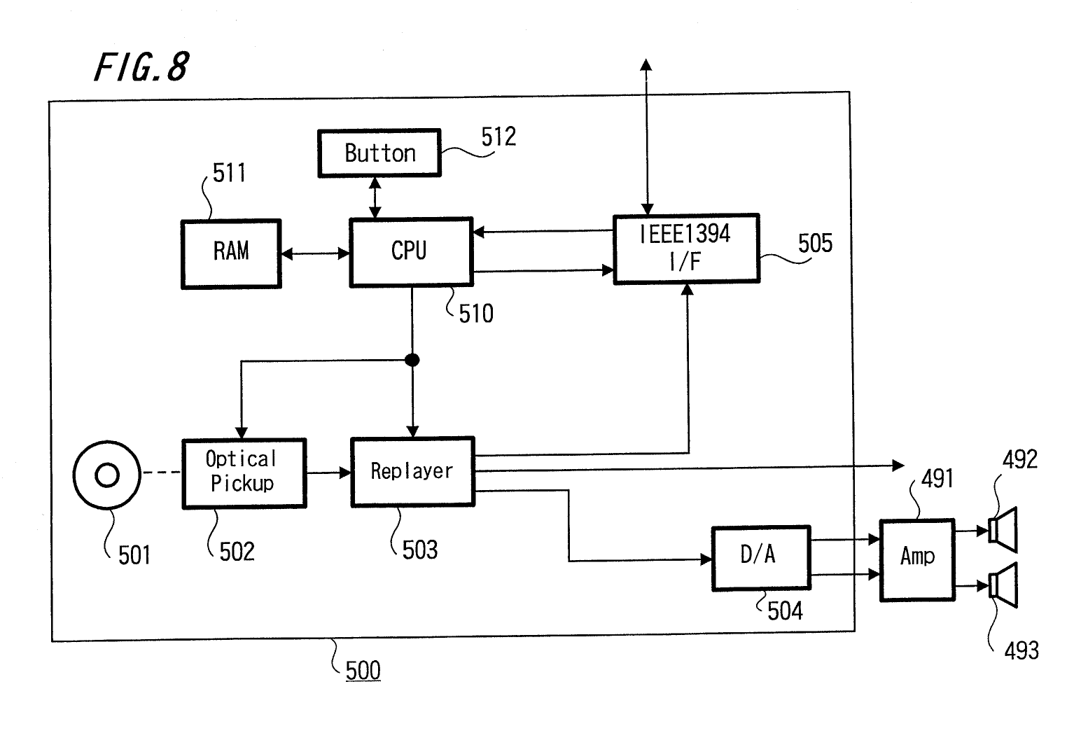

FIG. 8 is a block diagram showing a configuration of an audio player 500. The audio player 500 according to the present embodiment playbacks digital data recorded in a so-called CD (compact disc) which is an optical disc.

Data recorded in an optical disc 501 is read out by an optical pickup 502, and then processed by the replayer 503 for the playback, to obtain digital audio data. This audio playback data is supplied to a digital/analog converter 504, where the data is converted into analog, two-channel audio signal for output. If the digital audio data is to be outputted directly to an external device, the digital audio data as processed by the replayer 503 is directly outputted, without interception by the digital/analog converter 504. Note that according to the embodiment shown in FIG. 8, the analog audio output signal as converted is first supplied to the amplifier 491, where amplification and other processing necessary for the audio output are performed, and then to the speakers 492, 493 for two-channel sound (audio) output.

The audio player 500 further includes an interface 505 for connection with the IEEE 1394 bus line, so that audio data played back from a disc 501 can be supplied to the interface 505 for transmission through the IEEE 1394 bus line.

The above playback operation, and transmission operation via the interface 505, performed in the audio recorder/player 500 are controlled by a central processing unit (CPU) 510. The CPU 510 is connected with a memory 511 which is a work RAM. Further, the CPU 510 is supplied with operation information from a control panel 512, so that the control operations are made in accordance with such operation information. Still further, when the interface 505 receives control data such as an AV/C command via the IEEE 1394 bus line, the received data is supplied to the CPU 510, and the CPU 510 makes responsive control operation.

Next, description will be made for a process configuration for data transmission performed in the IEEE 1394 bus line that interconnects all of the devices described above.

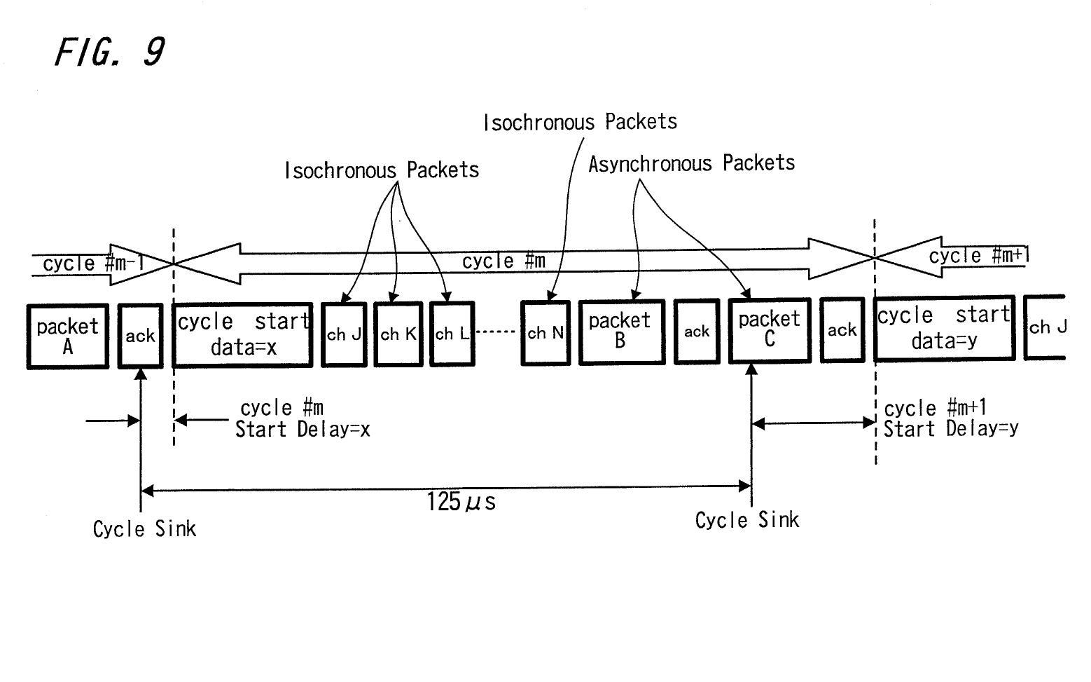

FIG. 9 is a chart showing a cycle structure of data transmission for the device interconnected by the IEEE 1394. In the IEEE 1394, data is divided into packets and transmitted in time sharing in a standardized cycle of 125 μs. This cycle is started by a cycle start signal supplied by a node (i.e. any one of the devices on the bus) having a cycle master function. In every cycle, the isochronous packets occupy a head portion of the bandwidth (so called traditionally, although the cycle in fact is a period of time) as necessary for the transmission. For this reason, data transmission within a certain predetermined time is guaranteed in the isochronous transmission. However, the data will be lost if there is a transmission error, since there is no arrangement made for protection the data. On the other hand, the asynchronous transmission is performed by using the time not occupied for the isochronous transmission in each of the cycles. During this time, a node which has obtained access to the bus as a result of arbitration sends out asynchronous packets. In the asynchronous transmission, reliable transmission is guaranteed by using Acknowledge and Retry procedures, but transmission timing is not constant.

In order for a node to perform the isochronous transmission, the node must have isochronous transmission capability. Further, at least one of the nodes, each having the isochronous transmission capability, must also have cycle master capability. Still further, at least one of the nodes sharing the IEEE 1394 serial bus must have isochronous resource manager capability.

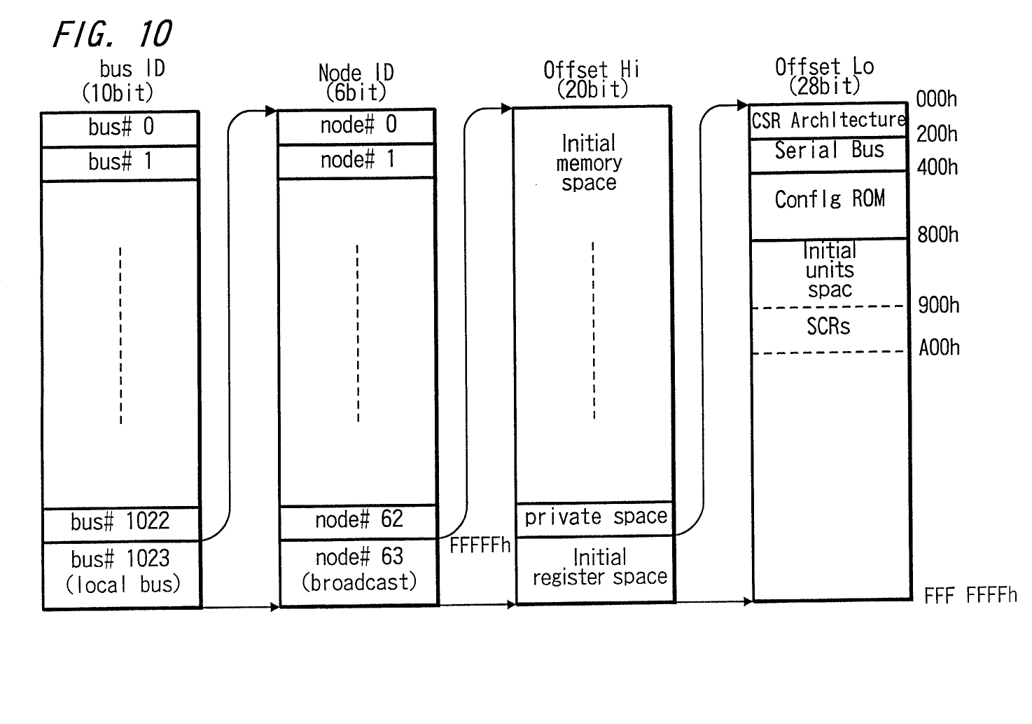

The IEEE 1394 is based on the CSR (Control & Status Register) architecture that uses 64-bit address space specified in ISO/IEC 13213. FIG. 10 shows the structure of the CSR architecture address space. The first 16 bits contains a node ID indicating a node on the IEEE 1394 bus, with the remaining 48 bits for assignment of the address space given to the node. The first 16 bits are divided into the first 10-bits portion which represents a bus ID, and the remaining 6-bits portion which represents a physical ID (the node ID in the narrow sense). With the exception of a case where all of the bits take the value “1”, that is reserved for a special purpose, possible combinations allow to specify 1023 buses and 63 nodes.

Out of the remaining 48 bits, a space provided by the first 20 bits are divided into subspaces for use by 2048-byte, CSR-specific registers and IEEE 1394 specific registers. Such subspaces include Initial Register Space, Private Space, and Initial Memory Space. The remaining space provided by the last 28 bits is utilized for a variety of purposes. For example, if the space provided by the higher 20 bits is Initial Register Space, the remaining space can be used as Configuration ROM (read only memory), Initial Unit Space for a node-specific use, Plug Control Registers (PCRs), and so on.

FIG. 11 shows typical offset addresses, names and functions of the CSR. The offset in FIG. 11 is an offset of the address from the address FFFFF0000000h (Numbers ending with the letter h are those expressed in hexadecimal notation), where Initial Register Space begins. Bandwidth Available Register, which has an offset 220h, shows a bandwidth allocable for isochronous transmission, and only a value stored in the node serving as the isochronous resource manager is valid. Specifically, each of the nodes has its CSR as shown in FIG. 10, but as for the information in Bandwidth Available Register, the information held by the isochronous resource manager is the only valid information. In other words, only the isochronous resource manager has Bandwidth Available Register in essence. When no bandwidth is allocated for the isochronous transmission, Bandwidth Available Register holds a maximum value, and the value decreases every time a bandwidth allocation is made.

Channel Available Register, which has offsets 224h through 228h, has its each of the bits correspond to respective one of the channel numbers 0 through 63. If the bit has a value “0”, the corresponding channel has already been allocated. The only valid Channel Available Register is that of the node serving as the isochronous resource manager.

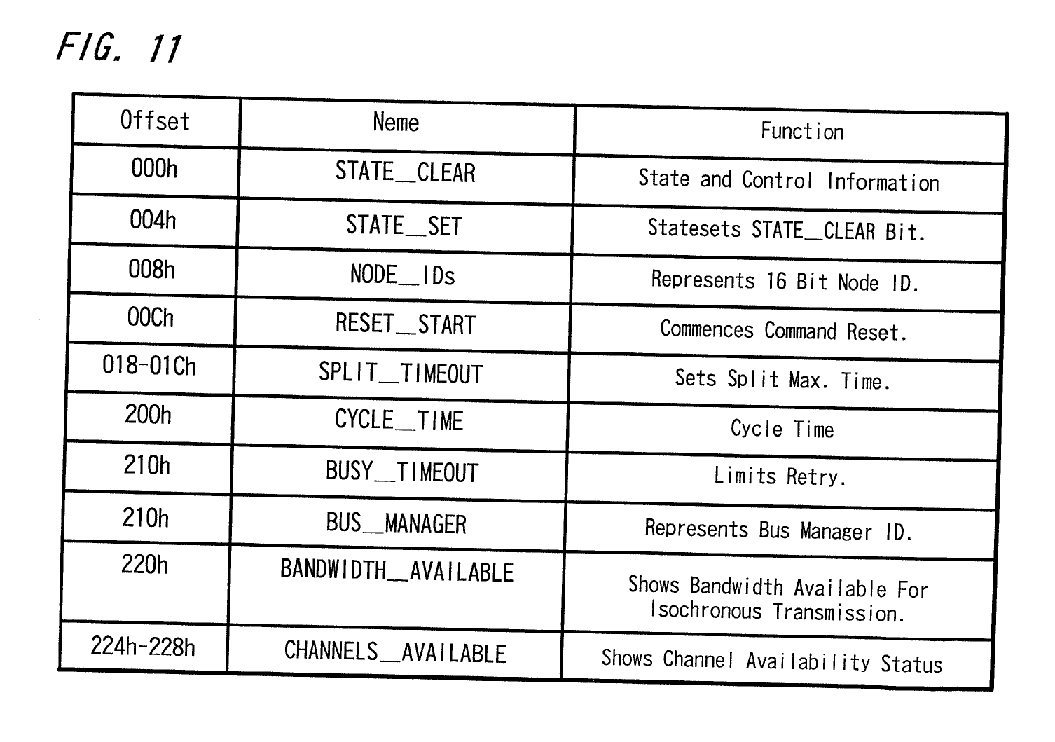

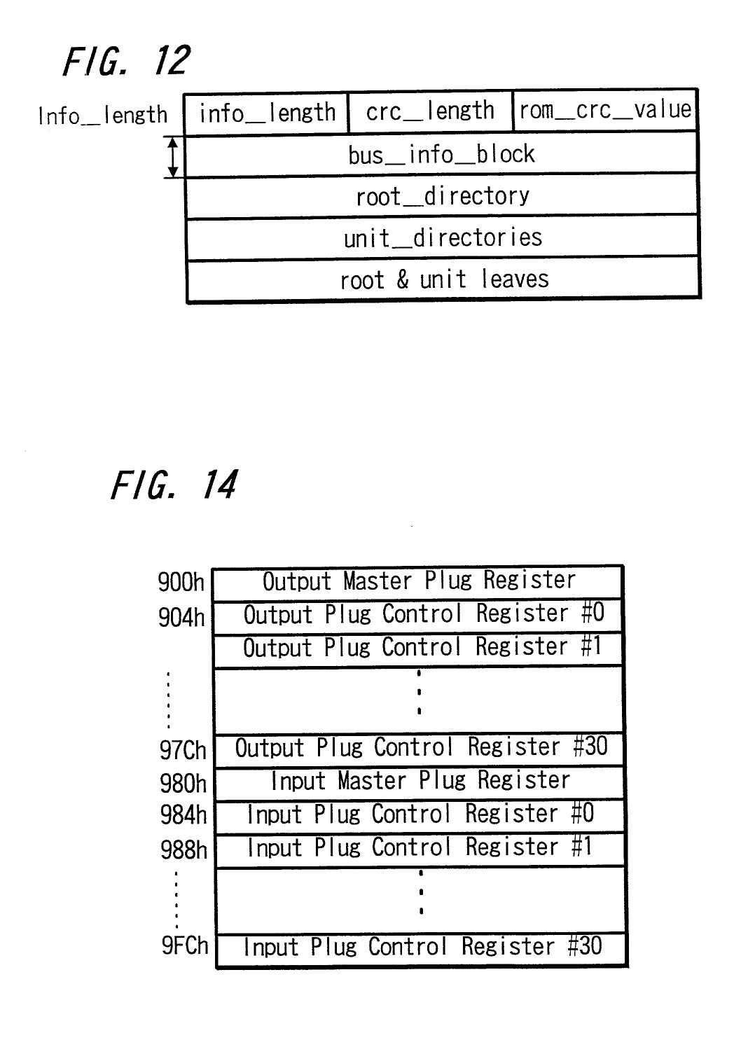

Returning to FIG. 10, Initial Register Space has a subspace provided by addresses 200h through 400h, where there is disposed a configuration ROM based on a general ROM format. FIG. 12 shows the general ROM format. The node, which is the unit of access on the IEEE 1394 network, can have a plurality of units each sharing the address space in the node but operating independently. Unit Directories can show software versions and locations applied to the units. Locations of Bus Info Block and Root Directory are fixed, but locations of the other blocks are assigned by offset addresses.

FIG. 13 shows details of Bus Info Block, Root Directory and Unit Directory. Bus Info Block has a “Company ID” field, where an ID number representing the manufacturer of the device is stored. “Chip ID” fields store a device-specific, world's only one ID that is not shared by any other devices. Further, in accordance with the IEC 61883 standards, a device which conforms to the IEC 61883 standards has its Unit Directory filled with unique information. Specifically, Unit Spec ID field has its first octet filled with 00h, the second octet filled with Aoh, and the third octet filled with 2Dh. Further, Unit Switch Version field has its first octet filled with 01h, whereas the third octet has its LSB (Least Significant Bit) filled with “1”.

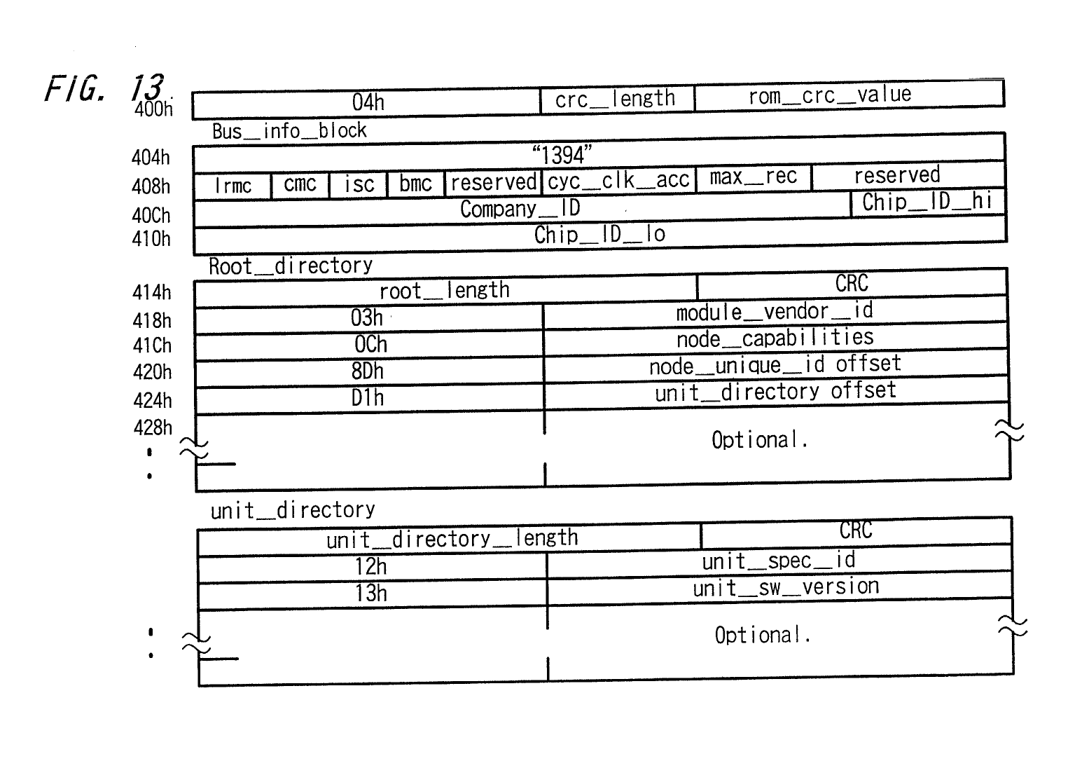

In order to achieve its input-output control via the interface, the node has a PCR (Plug Control Register) specified in IEC 1883, in addresses 900h through 9FFh in Initial Unit Space shown in FIG. 10. This is a substantialization of a conceptual plug, so as to form a signal path logically similar to an analog interface. FIG. 14 shows a structure of the PCR. The PCR has an oPCR (output Plug Control Register) which represents an output plug, and an iPCR (input Plug Control Register) which represents an input plug. Also, the PCR has an oMPR (output Master Plug Register) and an iMPR (input Master Plug Register), which respectively store information on the output plug and the input plug unique to each device. An individual device does not have a plurality of oMPRs or iMPRs, but can have a plurality of oPCRs and iPCRs correspondingly to the plugs, depending on ability of the device. The PCR shown in FIG. 14 has 31 oPCRs and iPCRs each. By operating the registers corresponding to these plugs, isochronous data flow is controlled.

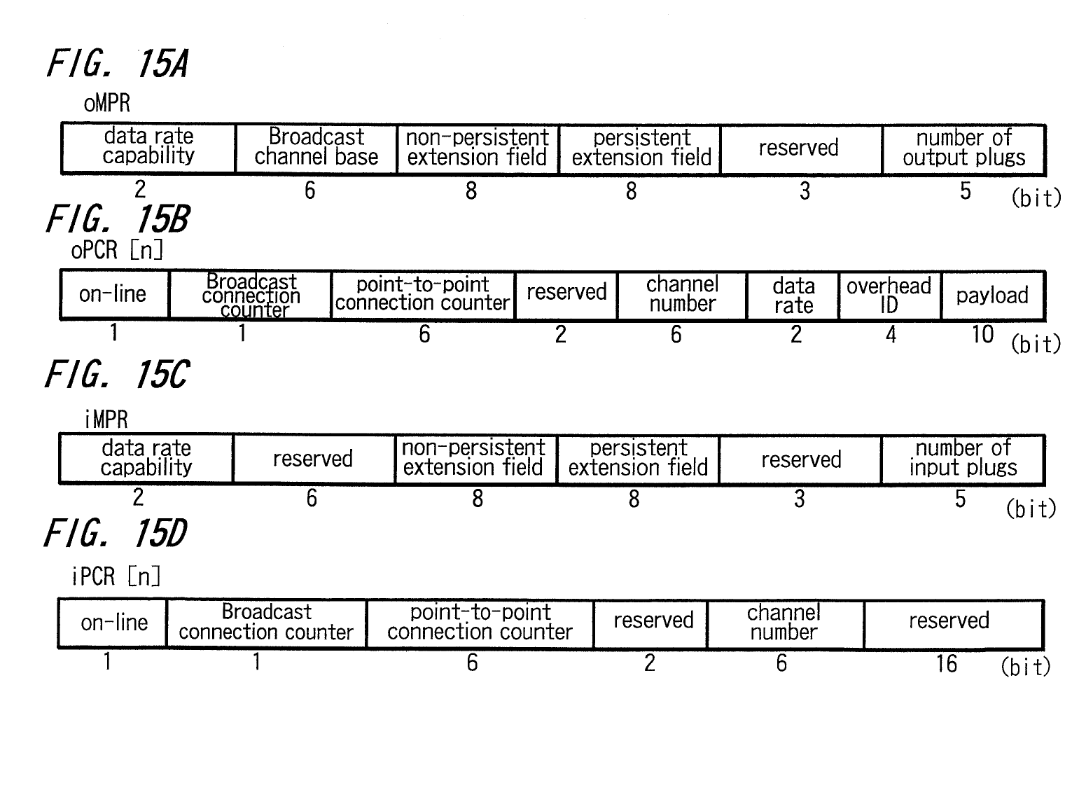

FIG. 15 shows structures of the oMPR, oPCR, iMPR and iPCR Specifically, FIG. 15A shows a structure of the oMPR, FIG. 15B shows a structure of the oPCR, FIG. 15C show a structure of the iMPR, and FIG. 15D shows a structure of the iPCR. Each of the oMPR and the iMPR has a two-bit “data rate capability” field on its MSB side, for storage of a code indicating a maximum transmission rate of isochronous data transmittable or receivable by this particular device. The oMPR has a “broadcast channel base” field for define of a channel number to be used for broadcast output.

The oMPR has a five-bit “number of output plugs” field on its LSB side for storage of the number of output plugs, i.e. the number of oPCRs, that belong to this particular device. The iMPR has a five-bit “number of input plugs” field on its LSB side for storage of the number of input plugs, i.e. the number of iPCRs, that belong to this particular device. A “non-persistent extension field” and a “persistent extension field” are defined for future extension.

Each of the oPCR and the iPCR has an “on-line” field of MSB that indicates line status of the plug. Specifically, if the field has a value “1”, the plug is on-line, whereas the plug is off-line if the field has a value “0”. Each of the oPCR and the iPCR has a “broadcast connection counter” field that indicates presence (1) or absence (0) of a broadcast connection. Each of the oPCR and the iPCR has a six-bit “point-to-point connection counter” field, and a value in this field shows the number of point-to-point connections that this particular plug has.

Each of the oPCR and the iPCR has a six-bit “channel number” field, and a value in this field shows the channel number of isochronous channel to which the plug is connected. The oPCR has a two-bit “data rate” field, and a value in this field shows an actual transmission rate of the isochronous data packets outputted from this plug. The oPCR has a four-bit “overhead ID” field that stores a code indicating an overhead bandwidth of the isochronous transmission. The oPCR has a ten-bit “payload” field, and a value in this field shows a maximum value of data contained in the isochronous packet that can be handled by the plug.

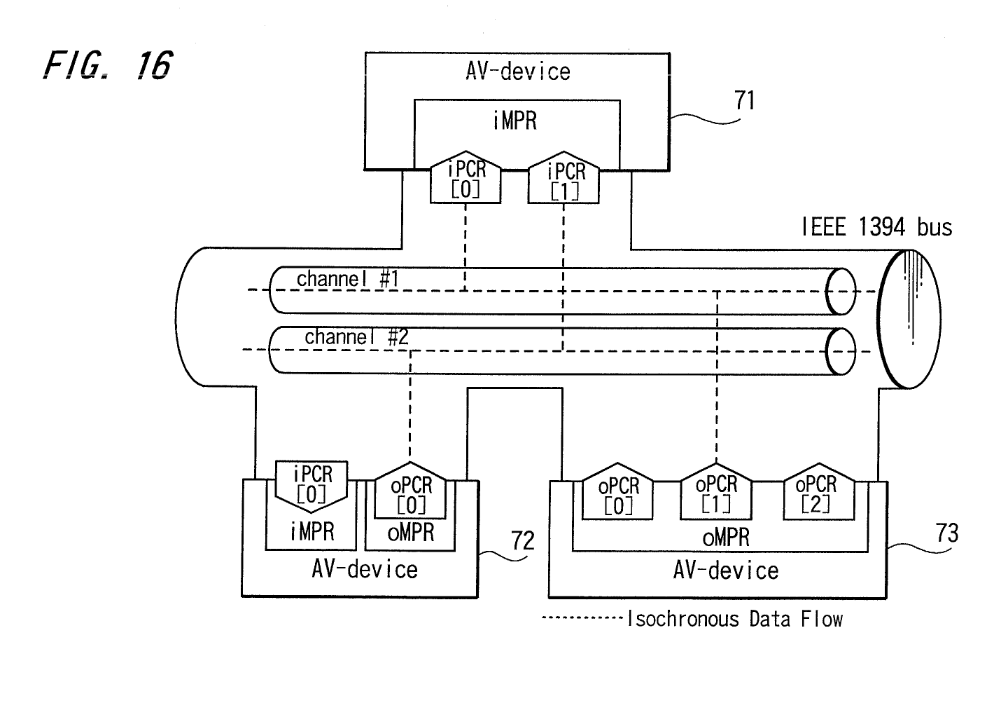

FIG. 16 shows a relationship among the plugs, the plug control registers and the isochronous channels. AV devices 71 through 73 are interconnected by an IEEE serial bus. The AV device 73 has an oMPR, which specifies a transmission rate and the number of oPCRs, i.e. the device has oPCR [0] through oPCR [2]. The oPCR [1] specifies isochronous channel for transmission of isochronous data, and the isochronous data is sent out onto channel #1 of the IEEE 1394 serial bus. The AV device 71 has an iMPR, which specifies a transmission rate and the number of the iPCRs, i.e. the device has iPCR [0] and iPCR [1]. Of these iPCRs, the iPCR [0] specifies channel #1 and the rate, and thus the AV device 71 receives the isochronous data transmitted via the channel #1 of the IEEE 1394 serial bus. Likewise, the AV device 72 sends out isochronous data onto channel #2, following specification by its oPCR[0], whereas the AV device 71 receives the isochronous data via the channel #2, following specification by its iPRC [1].

As has been described, data transmission is performed between devices which are interconnected via the IEEE 1394 serial bus. According to the system in the present embodiment, it is possible to control each of the devices, to know status of the devices, and so on by using the AV/C command set which is a set of commands specified for controlling devices interconnected via the IEEE 1394 serial bus. Description will now cover the AV/C command set.

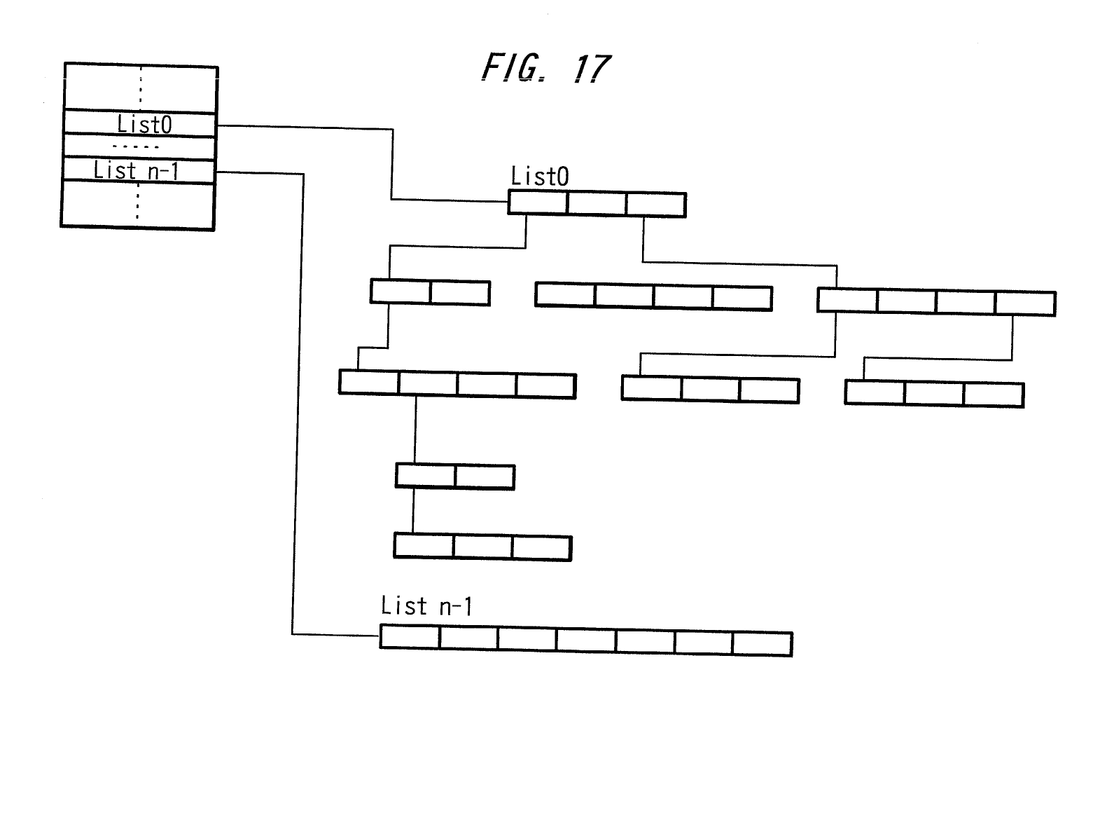

First, description will cover a data structure of Subunit Identifier Descriptor of the AV/C command set used in the system according to the present embodiment, with reference to FIG. 17 through FIG. 20. FIG. 17 shows the data structure of the Subunit Identifier Descriptor. As shown in FIG. 17, the Subunit Identifier Descriptor is provided by hierarchical lists. The list includes, for example, receivable channels if it is for a tuner. Likewise, the list for a disc includes titles of recorded music for example. The list which ranks the highest in the hierarchy is called root list. For example, List 0 serves as a root list of its subordinate lists. Likewise, there can be other lists serving as root lists. The root lists exists as many as objects. Here, the term object refers to each of the digital broadcast channels for example, if the AV device connected via the bus is a tuner. All of the lists in the same hierarchy share common information.

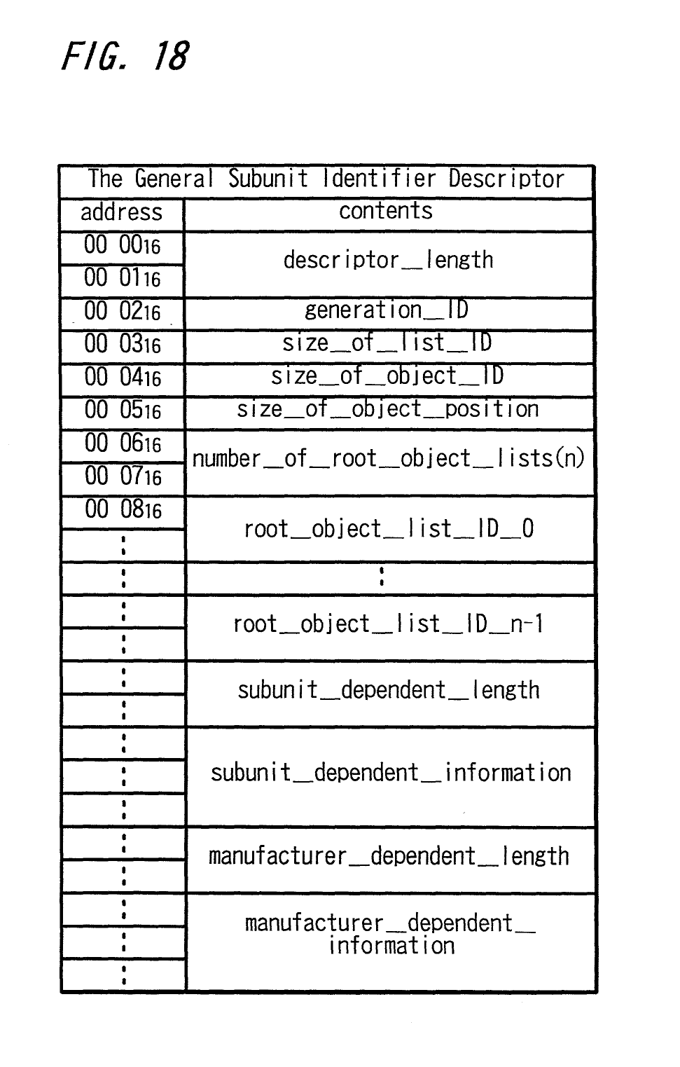

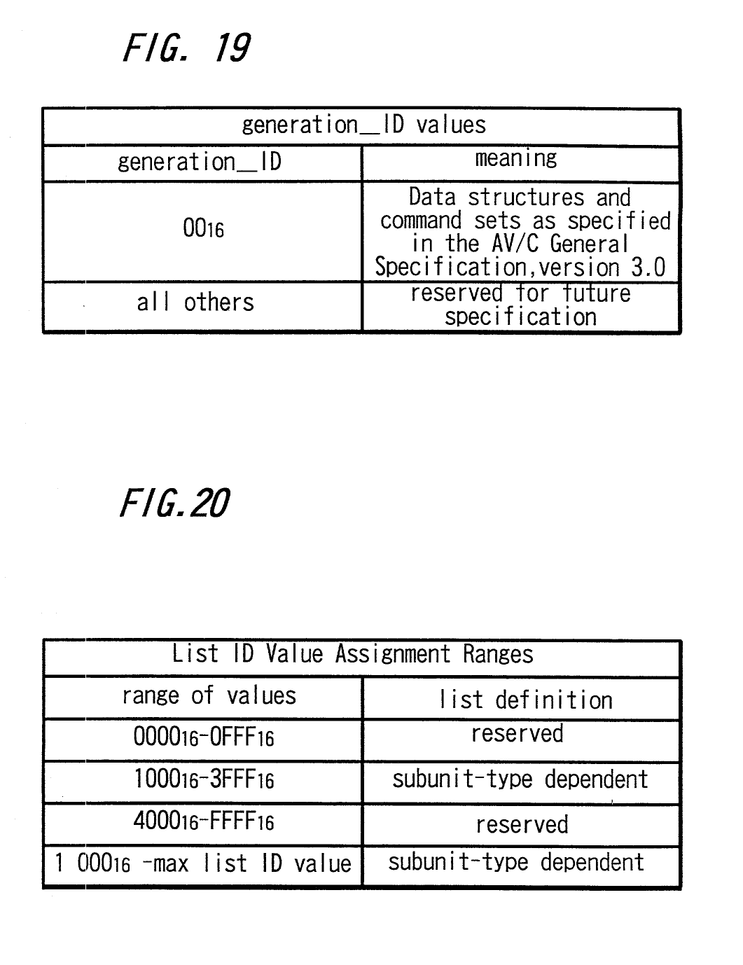

FIG. 18 shows a format of General Subunit Identifier Descriptor. The Subunit Descriptor contains description of attribute information about function. A “descriptor length” field does not contain a value of the field itself. Generation ID indicates a version of the AV/C command set, and can contain a value “00h” for example. (The letter h means the number is a hexadecimal notation.) The value “00h” means that the data structure and commands are of version 3.0 of the AV/C General Specification, as shown in FIG. 19 for example. Further, as also shown in FIG. 19, all of the values but for “00h” are reserved for future specification.

Size of List ID shows the number of bytes of the list ID. Size of Object ID shows the number of bytes of the object ID. Size of Object Position shows a location in the list (the number of bytes) to be used for reference in control operation. Number of root object list shows the number of root object lists. Root Object List ID is an ID for identifying the highest root object list in the hierarchy which is independent of each other.

Subunit Dependent Length shows the number of bytes of the following Subunit Dependent Information Data. The Subunit Dependent Information Data is a field storing function specific information. Manufacturer Dependent Length shows the number of bytes of the following Manufacturer Dependent Information. The Manufacturer Dependent Information is a field storing spec information unique to the vender (manufacturer). However, this field is not provided if the descriptor does not contain any manufacture-specific information.

FIG. 20 shows ranges of allocations of the list IDs shown in FIG. 18. As shown in FIG. 20, ranges from 0000h through 0FFFh and from 4000h through FFFFh are reserved as allocation ranges for future specifications. Ranges “1000h through 3FFFh” and “1000h through max list ID value” are for identification of function type subordinate information.

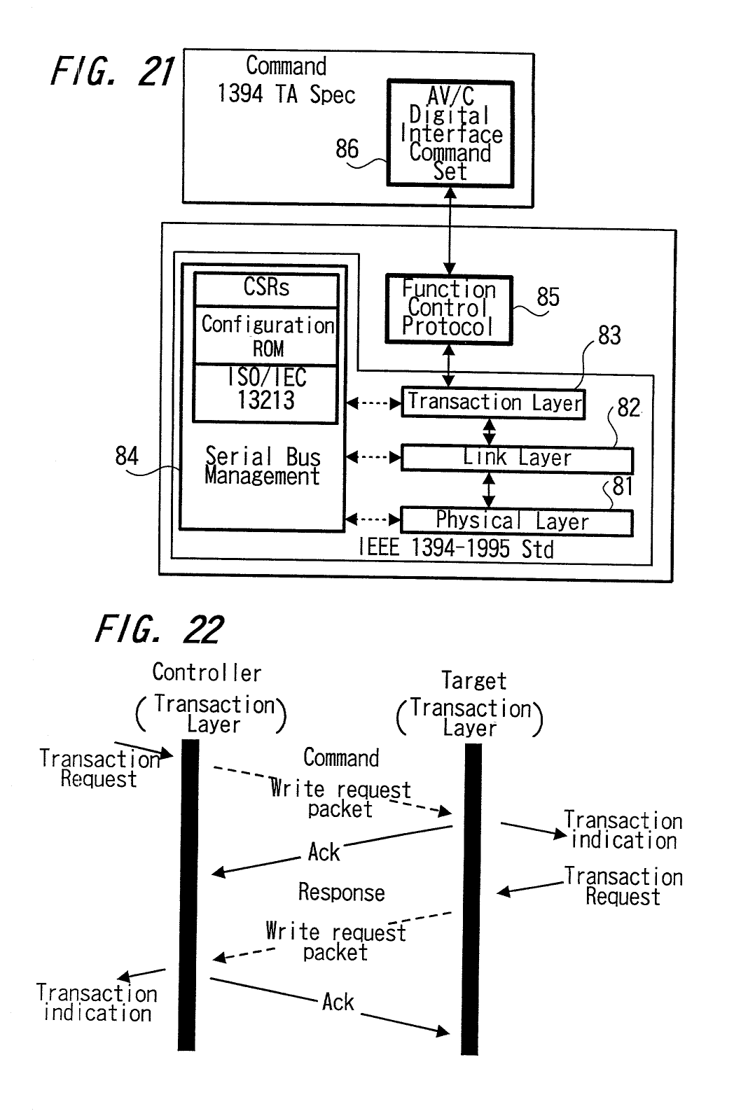

Next, description will cover the AV/C command set used in the system according to the present embodiment, with reference to FIG. 21 through FIG. 25. FIG. 21 shows a stack model of the AV/C command set. As shown in FIG. 21, a physical layer 81, a link layer 82, a transaction layer 83, and Serial Bus Management 84 conform to the IEEE 1394 standards. FCP (Function Control Protocol) 85 confirms to the IEC 61833, whereas an AV/C command set 86 conforms to the 1394 TA specifications.

FIG. 22 illustrates a command and a response in the FCP 85 in FIG. 21. The FCP 85 is a protocol for performing control on devices (nodes) on the IEEE 1394 bus. As shown in FIG. 22, a device on a controlling side is a controller, and a device on a controlled side is a target. Transmission of FCP commands and responses is performed by using a WRITE transaction in the IEEE 1394 asynchronous transmission between the nodes. Upon reception of data, the target confirms the reception by sending an acknowledgment to the controller.

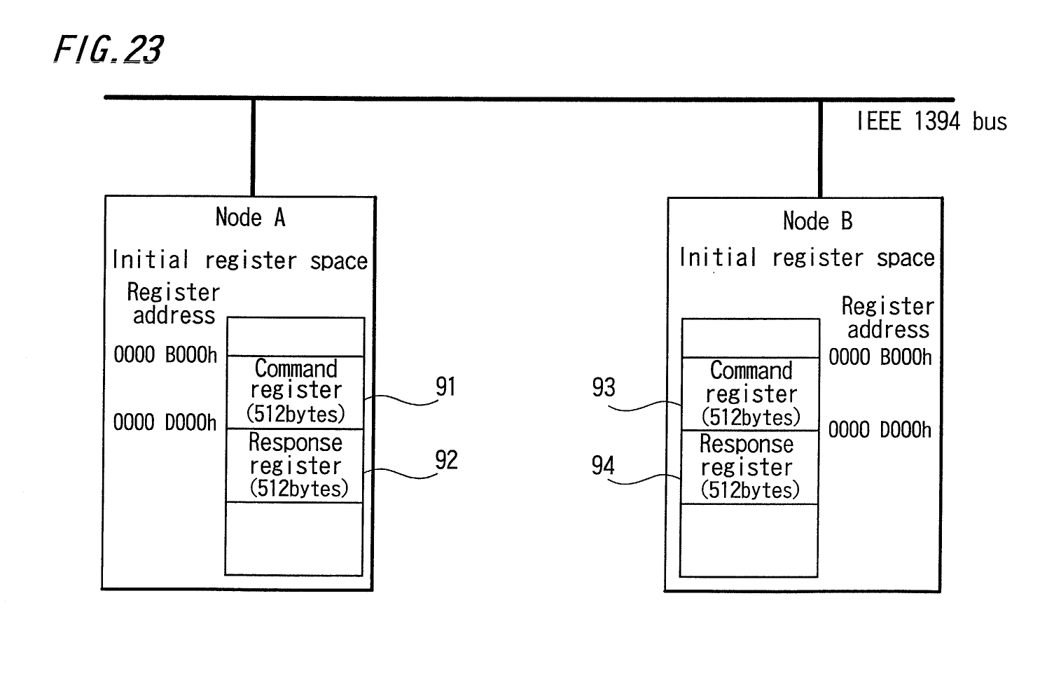

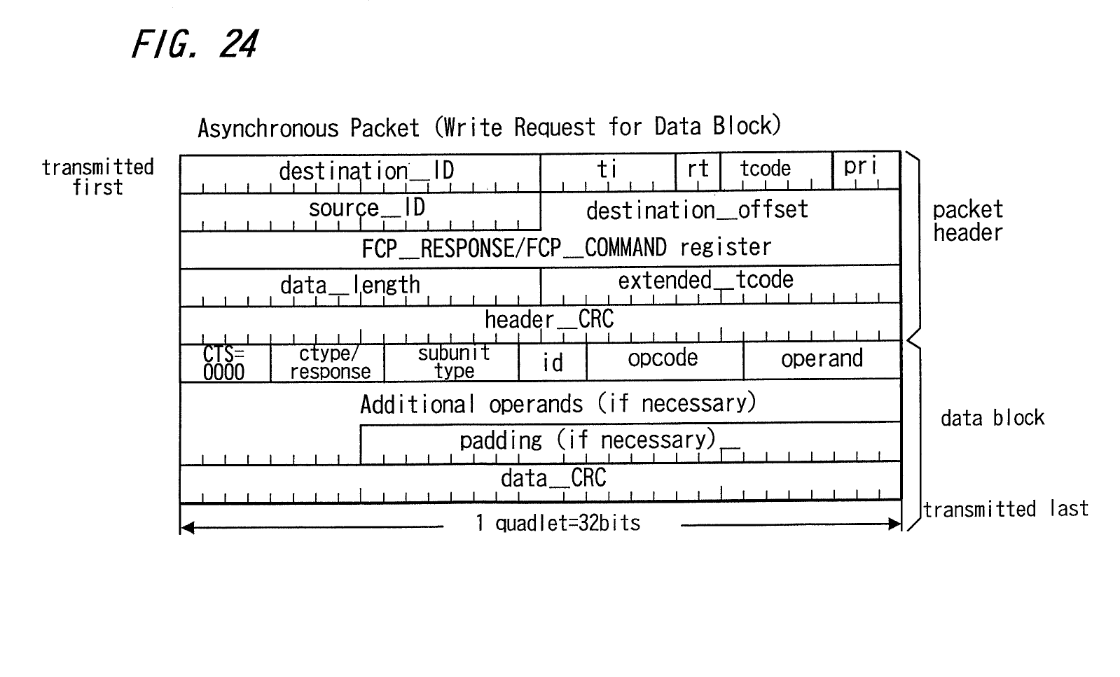

FIG. 23 gives a more detailed illustration of the FCP command-response relationship shown in FIG. 22. The IEEE 1394 bus interconnects a node A and a node B. The node A is the controller, and the node B is the target. Each of the node A and the node B has a command register and a response register, each having the size of 512 bytes. As shown in FIG. 23, the controller writes a command message in a command register 93 of the target, thereby giving an instruction. On the contrary, the target writes a response message in a response register 92 of the controller, thereby giving a response. Together with these two messages, control data are exchanged. A type of the command set transmitted in the FCP is written in CTS in a data field shown in FIG. 24 to be described later.

FIG. 24 shows a data structure in the packet transmitted in the asynchronous transmission mode of the AV/C command system. The AV/C command set is a set of commands for controlling AV devices, with its CTS (ID of the command set)=“0000”. An AV/C command frame and a response frame are sent and received between the nodes by using the FCP. In order to reduce burden to the bus and the AV devices, the response to the command is made within 100 ms. As shown in FIG. 24, data in the asynchronous packet is made of 32-bit rows extending in a horizontal direction (32 bits=1 quadlet). Top rows in the figure shows a header portion of the packet whereas lower rows in the figure show a data block. Destination ID indicates an address.

The CTS indicates an ID of the command set. In the AV/C command set, the CTS is given a value “0000”. A field “ctype/response” indicates a function classification of the command if the packet is a command, and if the packet is a response, indicates a result of processing the command. The commands are roughly classified into four kinds: (1) command for controlling a function from outside (CONTROL); (2) command for inquiring a status from outside (STATUS); (3) command for inquiring presence of support of a control command (GENERAL INQUIRY (presence or absence of opcode support)) and (SPECIFIC INQUIRY (presence or absence of opcode and operand support)); and (4) command for requesting a notice on a status change to outside (NOTIFY).

The response takes different forms depending on the kind of the command received. Specifically, the responses to the CONTROL command include NOT IMPLEMENTED, ACCEPTED, REJECTED, and INTERIM. The responses to the STATUS command include NOT IMPLEMENTED, REJECTED, IN TRANSITION, and STABLE. The responses to the GENERAL INQUIRY command and the SPECIFIC INQUIRY command include IMPLEMENTED and NOT IMPLEMENTED. The responses to the NOTIFY command include NOT IMPLEMENTED, REJECTED, INTERIM and CHANGED.

A “subunit type” field is provided for identifying a function within the device. Examples of assignment to the field are “tape recorder/player” and “tuner”. In addition to the function relevant to the device, the “subunit type” field also has an assignment for BBS (Bulletin Board Subunit) which is a subunit that discloses information to other devices. In order to handle a situation in which there is a plurality of subunits of the same kind, an identification number is provided in a “subunit id” field for a purpose of addressing. An “opcode” field holds a command, and an “operand” field holds a parameter of the command. An “Additional operands” field is an extra field added as needed. The operand is followed by “zero” data, for example, as needed. A “data CRC” (Cyclic Redundancy Check) field is used for error checking at the time of data transmission.

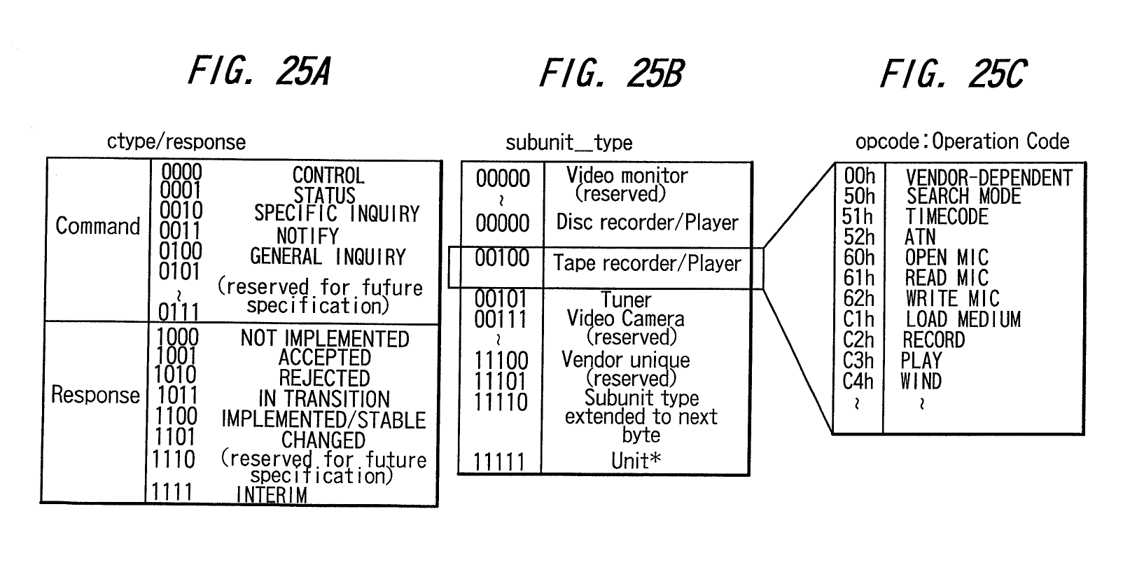

FIG. 25 shows specific examples of the AV/C commands. The left table in FIG. 25 shows examples of command type/responses. The table includes an upper box listing the commands, and a lower box listing the responses. CONTROL is assigned to “0000”, STATUS is assigned to “0001”, SPECIFIC INQUIRY is assigned to “0010”, NOTIFY is assigned to “0011” and GENERAL INQUIRY is assigned to “0100”. The numbers from “0101” through “0111” are reserved for future specifications. NOT IMPLEMENTED is assigned to “1000”, ACCEPTED is assigned to “1001”, REJECTED is assigned to “1010”, IN TRANSITION is assigned to “1011”, IMPLEMENTED/STABLE is assigned to “1100”, CHANGED is assigned to “1101”, and INTERIM is assigned to “1111”. The number “1110” is reserved for a future specification.

The middle table in FIG. 25 shows examples of “subunit type”. “Video monitor” is assigned to “00000”, “Disc reorder/Player” is assigned to “00011”, “Tape recorder/Player” is assigned to “00100”, “Tuner” is assigned to “00101”, and “Video camera” is assigned to “00111”. The subunit called BBS Bulletin Board Subunit), which is subunit used as a bulletin board, is assigned to “01010”. “Vendor unique”, which is a subunit type unique to the manufacturer, is assigned to “11100”, and “Subunit type extended to next byte” is assigned to “11110”. A subunit type “Unit” assigned to “11111” is used when the command is directed to the commanding unit itself, e.g. when turning the power ON/OFF.

The right table FIG. 25 shows examples of the “opcode” (operation code). There is an opcode table for each of the “subunit type”. This particular table shows “opcode” examples for the “subunit type” being “Tape recorder/Player”. Further, each of the “opcodes” has a set of operands defined. In this particular example, VENDOR-DEPENDENT, which has a manufacturer specific value, is assigned to “00h”, SEARCH MODE is assigned to “50h”, TIME CODE is assigned to “51h”, ATN is assigned to “52h”, OPEN MEMORY is assigned to “60h”, READ MEMORY is assigned to “61h”, WRITE IN MEMORY is assigned to “62h”, LOAD is assigned to “C1h”, RECORD is assigned to “C2h”, PLAY is assigned to “C3h”, and REWIND is assigned to “C4h”.

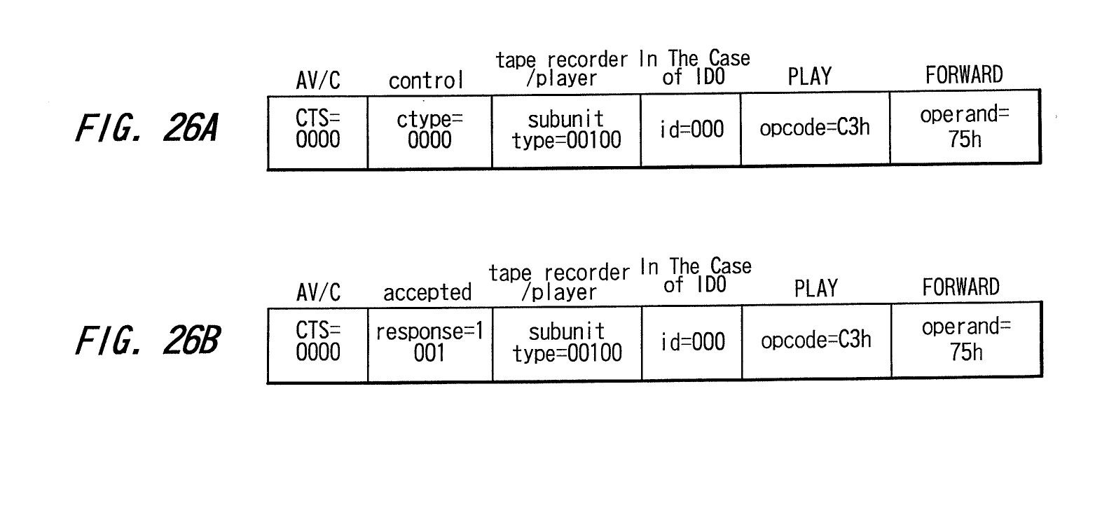

FIG. 26 shows specific examples of an AV/C command and a response thereto. If a playback instruction is issued to a playback device as a target (consumer) for example, the controller sends a command as shown in FIG. 26A. Since this command uses the AV/C command set, the CTS is “0000”. Since the command is a controlling command (CONTROL) for controlling the device from outside, the field “ctype” (command type) holds a value “0000” (See FIG. 25.) Since the device is a tape recorder/player, the field “subunit type” holds a value “00100” (See FIG. 25.) The example shows a case in which the ID is zero; therefore, the “ID” field holds a value “000”. The operation code is “C3h” which means playback (See FIG. 25.) The operand is “75h” which means forward. Upon the playback, the target sends a response as shown in FIG. 26B, to the controller. In this particular example, the response field holds ACCEPTED; therefore, the response field holds a value “1001” (See FIG. 25.) All the other fields but the response field are the same as in FIG. 26A, and therefore the description will not be repeated.

Next, description will cover a transmission processing according to the present embodiment, performed via the IEEE 1394 bus line which has been described above. The description will be based on a network configuration as shown in FIG. 3 for example, in which AV/C commands are exchanged between devices interlinked via the network. The description will take, in particular, a case in which the NOTIFY command is used. As has been described, the NOTIFY command is a notice-requesting command for requesting a counterpart device to send a notice upon a certain status change. Upon reception of the NOTIFY command, the counterpart device stores a cue in order to make sure that the notice instructed in the command can be issued. The storage of the cue can be performed in such a way that the memory connected with the central processing unit of the counterpart device provides a memory area, in which the node ID and so on of the issuer of the NOTIFY command are stored. Then, when controlling means discerns that the status change defined in the NOTIFY command has taken place, the notice on the status change is made to the device identified by the node ID stored in the cue. The notice is made by using the CHANGED response.

The NOTIFY command is used, for example, to have a target device notify when there has been a change in channel availability status or bandwidth availability status on the bus line. Specifically, as has been described earlier, the IEEE 1394 allows a device to establish a connection and to perform data transmission with another device via a predetermined channel and bandwidth of certain channels specifically allocated therefor; but it is only the device that has established the connection that is entitled to cease the connection thereby making the channel unoccupied. Therefore, another device wishing to use the channel can send the NOTIFY command to the occupying device and have the occupying device notify when the occupation of the channel has been ceased.

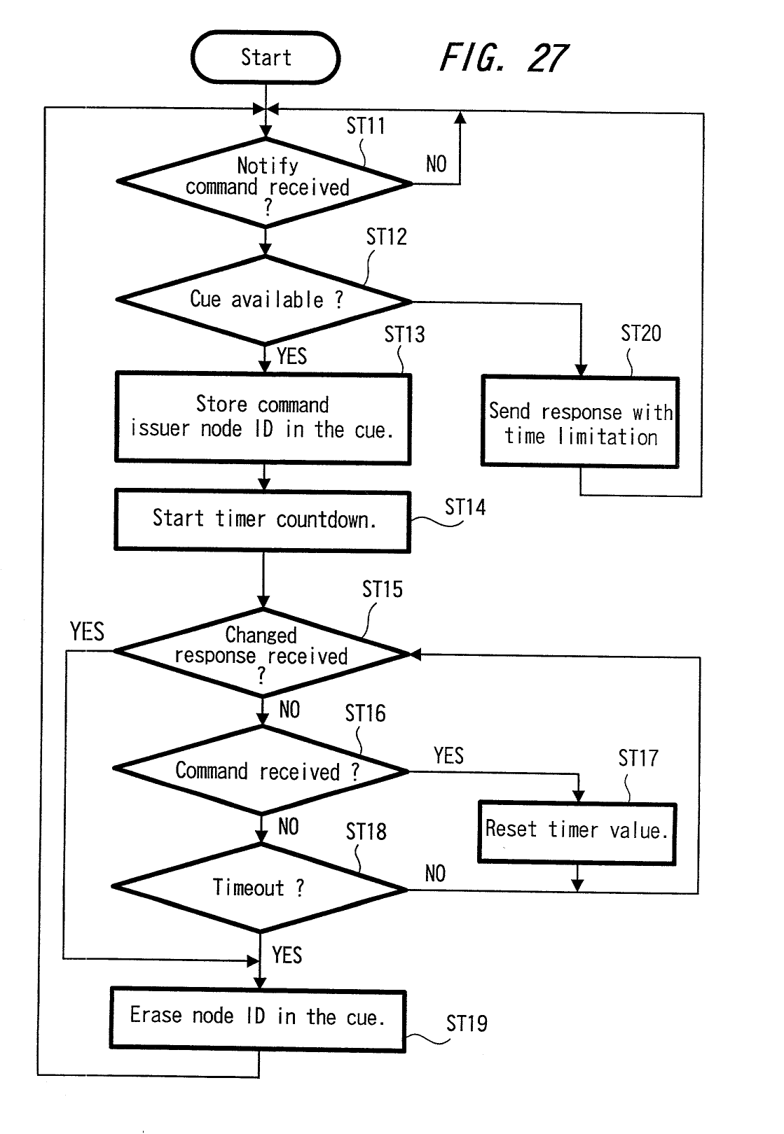

FIG. 27 is a flowchart showing a process example performed by a target device that has received a NOTIFY command according to the present embodiment. Hereinafter, description will be made following FIG. 27. First, controlling means (e.g. the central processing unit) of the device check if there is any NOTIFY command received via the bus line (Step ST11). This checking cycle is repeated as a standby state, until reception of a NOTIFY command is recognized. When it is discerned that the NOTIFY command has been received, a check is made to see if there is memory area available for the cue (Step ST12).

If it is discerned that there is available memory area for the cue, the node ID of the command issuer is stored in the memory area (Step ST13). Further, upon storing the cue, i.e. when the NOTIFY command has been properly processed, an INTERIM response is sent to the command issuer. It should be noted here that if it is necessary to store information on the status change for which the notice is asked, such information on the status change is also stored at the same time. However, it is not necessary to store such information on the status change if the memory area for the cue has a specific relevance with the kind of status change for which the notice is asked.

After the storing operation is complete in Step ST13, a countdown counter provided within the controlling means is started (Step ST14). This counter counts down a predetermined amount of time for which the instruction specified in the NOTIFY command is valid. The amount of time can be a few minutes, a few tens of minutes, and so on.

After commencing the countdown, the process checks to see if there is any status change as defined by the NOTIFY command, and need to be notify and if the status change takes place, a CHANGED response is sent to the node identified by the node ID stored in the cue. In this part of the process, the controlling means checks to see if the CHANGED response has been sent (Step ST15). If the response has already been sent, the process moves to Step ST19, where the data including the node ID stored in the cue memory is erased.

On the other hand, if it is discerned that the CHANGED response has not been sent in Step ST15, the process checks to see if there is the same NOTIFY command received again from the issuer (Step ST16). If it is discerned that the NOTIFY command has been transmitted again from the same issuer, then the counter, which was started in Step ST14, is reset to an initial value, and a new cycle of the countdown operation from the initial value is started (Step ST17).

On the other hand, if it is discerned that the NOTIFY command is not received again from the same issuer in Step ST16, then the process checks to see if the counter, which was started in Step ST14, has a value “0”, i.e. if the command has been expired (Step ST18). If the time is not over yet, or if the timer initial value is reset in Step ST17, the process goes back to Step ST15, to see if the CHANGED response has been sent.

If it is discerned in Step ST18 that the time is over, the process goes to Step ST19, where the data including the node ID stored in the cue memory is erased. After the erasing operation in Step ST19, the process goes back to Step ST11, on standby, until reception of another NOTIFY command. If the process discerns in Step ST12 that no memory area is available for a cue, a REJECTED response that rejects the notify command is sent (Step ST20). This response is accompanied by time information, which indicates how long it will take for the countdown counter for NOTIFY command (i.e. the counter started in Step ST14) to finish the current countdown. After the transmission of the response in Step ST20, the process goes back to the Step ST11.

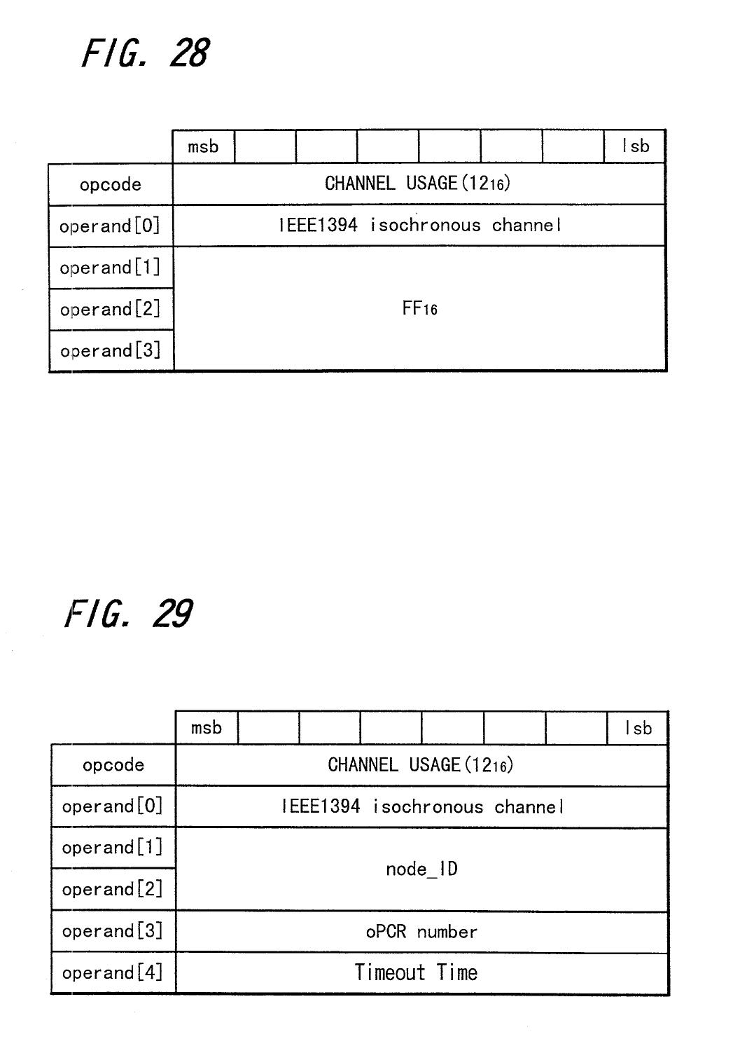

Now, an example of the NOTIFY command transmitted according to the present embodiment will be described. FIG. 28 shows an example of data configuration in the transmission of a NOTIFY command. The operation code data and operand data shown in this FIG. 28 are placed respectively in the “opcode” field and the “operand” field of the AV/C command packet shown in FIG. 24. The example shown in FIG. 28 is a NOTIFY command data for a notice on a status change in an isochronous channel; specifically, a request for a notice when there is a change in the channel availability status (or more specifically, when the channel becomes available.) In an “opcode” field, data on the channel availability status is placed, whereas an “operand [0]” field is filled with data indicating that the channel in question is the isochronous channel. All the other operand fields in this example are filled with a maximum value [FF]

A response to this command has a data configuration shown in FIG. 29 for example. As has been described earlier, the response in this case can be either an INTERIM response which informs that the NOTIFY command requesting the notice was accepted (the operation performed in Step ST13) or a REJECTED response which informs that the NOTIFY command requesting the notice was rejected (the operation performed in Step ST20). The two responses can be differentiated from each other by a data placed in the “response type” field of the AV/C command packet shown in FIG. 24. The response has its “opcode” field and “operand [0]” field, which are filled with the same data as in the corresponding command.

An “operand [1]” and the following fields are filled with data about current availability status of the isochronous channel. According to the example in FIG. 29, the “operand [1]” and “operand [2]” fields are filled with the node ID of the unit that is occupying the channel, and the “operand [3]” field is filled with data indicating the number of the output plug (oPCR) being used.

The “operand [4]” field is filled with the time data indicating when a timeout will be reached, based on the current value of the countdown counter. For example, assume that the counter is a 10-minute counter. If the response is an INTERIM response, the response is made right after the commencement of the countdown, and therefore a timeout time of 10 minutes is noticed. On the other hand, if the response is a REJECTED response, a timeout time that is a remaining time for the current cue memory that is being used now (and therefore shorter than 10 minutes) is noticed.

The examples in FIG. 28 and FIG. 29 illustrates only one NOTIFF command that requests a notice when there is a change in channel availability status, and responses given thereto. However, the case may be different; i.e. a set of NOTIFY command and responses thereto can also handle other cases in which notice is made for other status change. It should be noted here that if a NOTIFY command requests a notice when there is a change in channel availability status, the target device is a device that established the connection that occupies the channel currently. It should be noted further, that besides the channel availability, a set of a NOTIFY command and responses similar to the above may be used in relation to bandwidth availability on the bus line, for requesting a notice when there is a change in bandwidth availability.

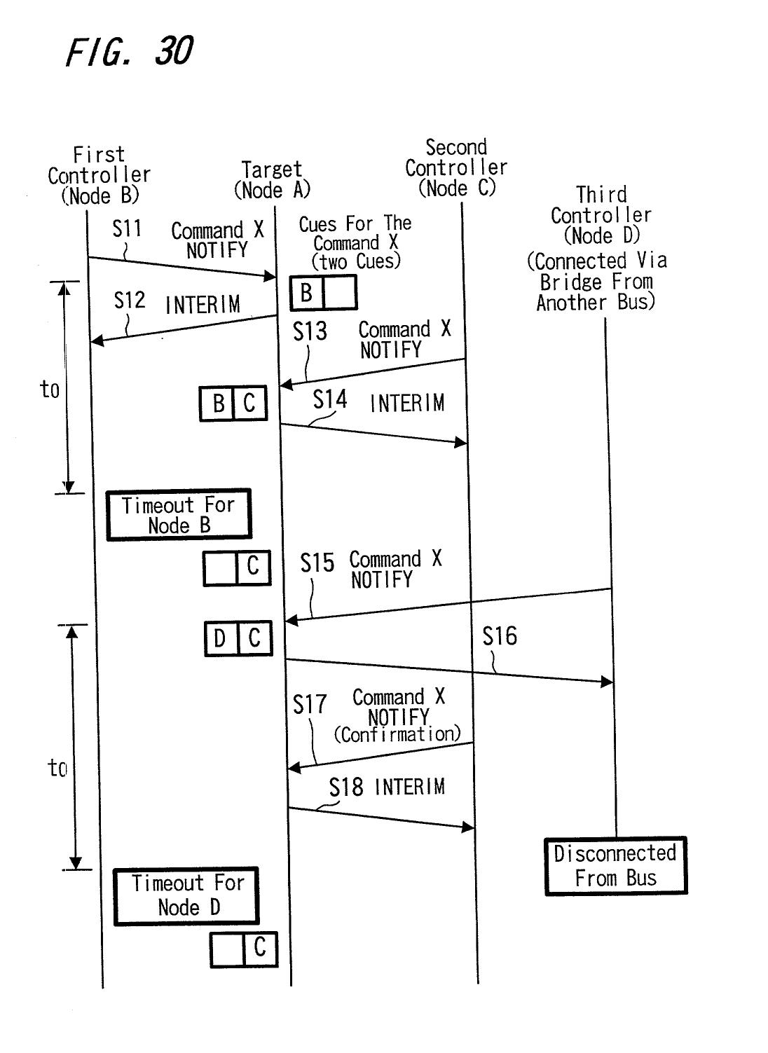

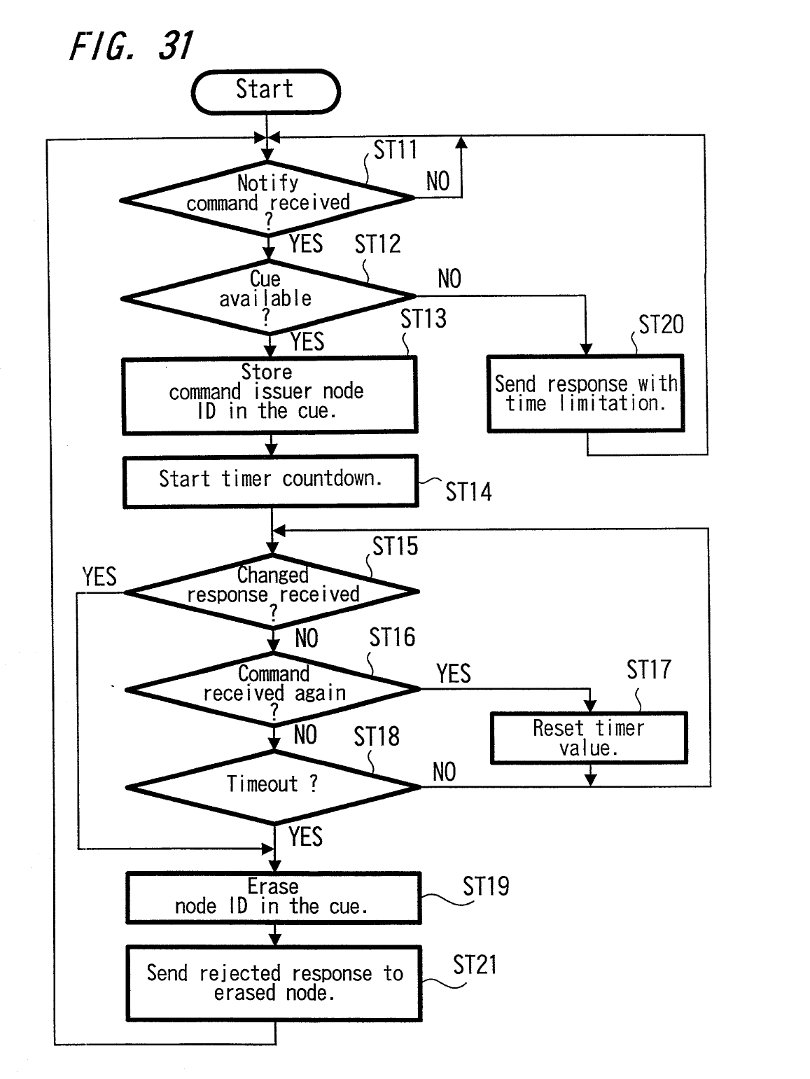

FIG. 30 is a chart showing a process example of a case when a NOTIFY command is transmitted via the network according to the present embodiment. The chart shows time-series changes in cue memory in a target device and transmission status of responses, etc.

According to this particular example based on the network configuration illustrated in FIG. 3, the target device is the node A device IRD (100), the node B device (the television receiver 200) is a first controller, the node C device (the video recorder/player 300) is a second controller, and the node D device (the audio recorder/player 400) is a third controller. The example shows a case in which each of the controllers send a NOTIFY command to the target. Further, the target (node A) in this example has two memory areas for two cues in relation to a status X.

Referring to FIG. 30, in the first place, the first controller (node B) sends to the target (node A) a NOTIFY command requesting a notice on a change in the status X (Step S11). Upon reception of this command, the target (node A) stores a node ID of the node B in one of the two memory areas for the cues, and then sends an INTERIM response (Step S12) to the first controller (node B), confirming the reception of the notify command. Also, upon performing the operation in Step S11, a countdown counter which measures a predetermined amount of tire t₀ is started.

Next, assume that the second controller (node C) transmits to the target (node A) another NOTIFY command requesting a notice on the change in relation to the status X (Step S13). Upon reception of this command, the target (node A) stores a node ID of the node C in the remaining one memory area for the cues, and then sends an INTERIM response (step S14) to the second controller (node C), confirming the reception of the NOTIFY command.

Now, assume further, that upon processing thus far since the reception of the NOTIFY command from the node B, the time t₀, being measured by the counter in the target, has elapsed, to a timeout. Due to the timeout, the node ID of the node B stored in the cue memory is erased. The erasure of one of the cues from the memory areas allows the target to accept another NOTIFY command from another controller. Specifically, as shown in FIG. 30, when the third controller (node D) transmits to the target (node A) another NOTIFY command requesting a notice on the change in relation to the status X (step S15), the target stores a node ID of the node D in the available one memory area for the cue, and then sends an INTERIM response (Step S16) to the third controller (node D), confirming the reception of the NOTIFY command.

Continuing with the present example, assume further, that the second controller (node C) transmits to the target (node A) the NOTIFY command again (Step S17), requesting a notice on the change in relation to the status X, before (or right after) the NOTIFY command from the node C comes to a timeout, i.e. before the elapse of the time t₀ being measured by the counter in the target device. Upon reception of this NOTIFY command, the time setting in the counter is initialized. As a result, the cue of the node C is not erased but remains in the memory.

Now, assume further, that since the reception of the NOTIFY command from the node D, the time to being measured by the counter has elapsed to a timeout. Due to the timeout, the node ID of the node D stored in the cue memory is erased. Therefore, as shown in FIG. 28 for example, even if the third controller (node D) is disconnected from the network, the cue memory of the node ID of node D does not remain in the target device, enabling efficient use of the cue memory areas in the target device.

If a controller prefers to keep waiting for a notice to be issued on a NOTIFY command, the controller can make a confirmation by resending the NOTIFY command as performed in Step ST17, whereby the effective period is renewed and the NOTIFY command can remain effective. By repeating this renewal process of the effective period, the controller can keep waiting even for a long time. The controller can discern when the effective period will cease, based on the timeout information included in the response received right after the NOTIFY command is transmitted.

According to the processing described thus far, when a timeout is reached, the target device only erases the corresponding cue stored in the memory. Alternatively however, the target device may also notify the corresponding controller that the NOTIFY command is now void and thus the notice will not be made.

FIG. 31 is a flowchart that shows a process example in the above case. In this flowchart, process steps up to Step ST19 in which the node ID of the cue is erased at a timeout, are the same as in the flowchart shown in FIG. 27. According to the present example however, after the erasing operation in Step ST19, a REJECTED response is sent to the controller identified by the erased node ID, thereby notifying that the NOTIFY command is now void and the notice will not be made (Step S21). After the issuance of this notice, the process goes back to Step ST11 to a standby until reception of another NOTIFY command.

By notifying voidance, as described as above, the controller that receives the response can reliably discern that the NOTIFY command issued by itself has been voided, without the need for counting the time till the timeout.

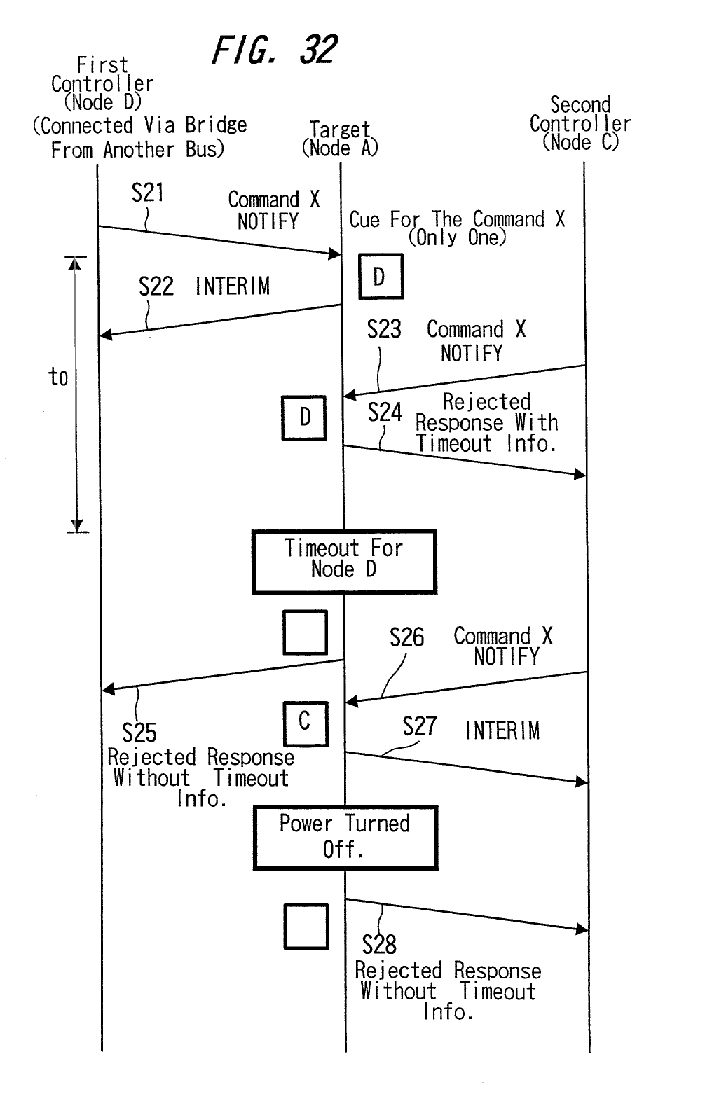

FIG. 32 is a chart showing a process example of a case in which a timeout is notified. The chart shows time-series changes in cue memory in a target device and transmission status of responses, etc. According to this particular example, a target device is a node A, a first controller is a node D, and a second controller is a node C. Further, the target has only one memory area for a cue.

Referring to FIG. 32, in the first place, the first controller (node D) sends to the target (node A) a NOTIFY command requesting a notice on a change in a status x (Step S21). Upon reception of this command, the target (node A) stores a node ID of the node D in the memory area for the cue, and then sends an INTERIM response (Step S22) to the first controller (node D), confirming acceptance of the NOTIFY command. Also, upon performing the operation in Step S22, a countdown counter which measures a predetermined amount of time to is started.

Next, assume that the second controller (node C) transmits to the target (node A) another NOTIFY command requesting a notice on the change in relation to the status X (Step S23). Upon reception of this command, the target (node A), which no longer has available memory for a cue, sends a REJECTED response, informing that the notice requested by the NOTIFY command will not be made (Step S24). This rejection response is accompanied by time information indicating the cue for the node D comes to a timeout.

When the time t₀ has elapsed since the cue of the first controller (node D) was stored in the memory, and the timeout is reached, the stored memory data of the cue is erased, upon which the target (node A) sends to the first controller (node D) a REJECTED response (Step S25), notifying that the NOTIFY command has been voided. This response does not include timeout information.

On the other hand, the second controller (node C) which received the rejection response before the timeout, can predict from the timeout information included in the rejection response when the timeout is reached. Therefore, the second controller (node C) can resend to the target (node A) the NOTIFY command (Step S26) requesting a notice on the change in relation to the status x right after the erasure of the cue memory of the node D for example, thereby having the NOTIFY command successfully accepted.

When this NOTIFY command is transmitted in Step S26, the node ID of the node C is stored in the available memory area for the cue, and then an INTERIM response, confirming acceptance of the NOTIFY command is sent (step S27) to the second controller (node C).

According to the description presented thus far, erasure of the cue memory is made upon the timeout. Alternatively however, the erasure of the cue memory may be made under a different condition. For example, the erasure of the cue memory may be made when power supply status of the target device main power is changed from ON state to OFF state, which leads to inability for the target device to make notification. (Power supply must be kept ON, however, to communications unit which performs data communications via the bus line.) According to the example in FIG. 32, when the main power to the target device is turned off, a REJECTED response indicating that the NOTIFY command is voided is sent (Step S28) to the controller (node C) identified by the cue in memory. No timeout information is attached to this response.

As described above, if a notice is made when voiding a NOTIFY command upon turning off the power for example, it becomes possible to eliminate a case in which the controlling device continues to wait for the notice on a change.

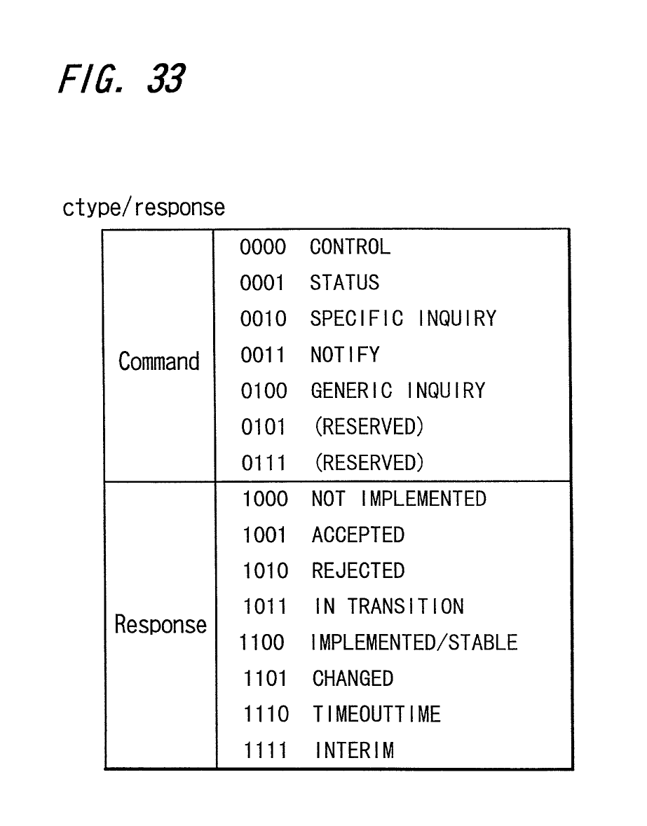

In the description presented thus far, the same REJECTED response has been used for both of the two kinds of responses, i.e. the response to notify voidance of a NOTIFY command due to timeout and the response to notify voidance of a NOTIFY command due to unavailability of cue memory area. Alternatively however, the responses may be different from each other. For example, the response which is transmitted when a NOTIFY command is rejected due to unavailability of cue memory area (so called cue overflow) may be newly defined by using an unused data value. Specifically, as shown in FIG. 33, a value “1110” may be used to define [TIMEOUT TIME], indicating the cue overflow (and the rest of the format is common to those of the other commands and responses shown in FIG. 25.) When response is made at a time of cue overflow, this [TIMEOUT TIME] response is transmitted, so that the device on the receiving side can predict, from timeout information attached to the response, when the next NOTIFY command can be accepted.

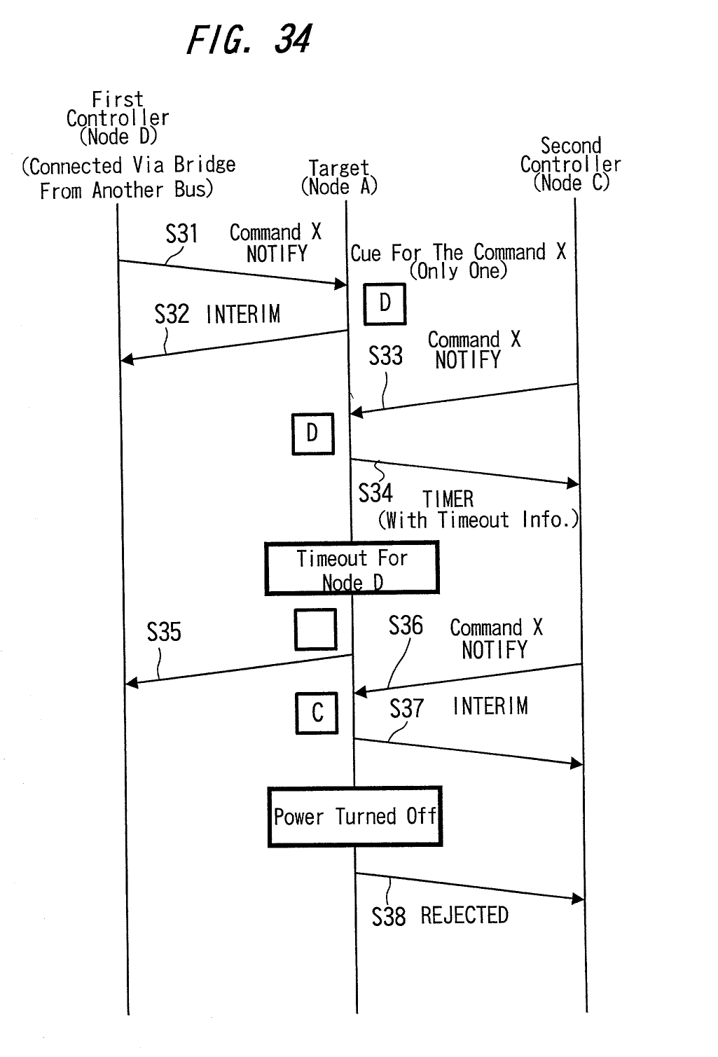

FIG. 34 is a chart showing a process example in which the above-described response is used. The chart shows time-series changes in cue memory in a target device and transmission status of responses, etc. According to this particular example, a target device is a node A, a first controller is a node D, and a second controller is a node C. Further, the target has only one memory area for a cue.

Referring to FIG. 34, in the first place, the first controller (node D) sends to the target (node A) a NOTIFY command requesting a notice on a change in a status X (Step S31). Upon reception of this command, the target (node A) stores a node ID of the node D in the memory area for the cue, and then sends an INTERIM response (Step S32) to the first controller (node D), confirming acceptance of the NOTIFY command. Also, upon performing the operation in Step S22, a countdown counter which measures a predetermined amount of time to is started.

Next, assume that the second controller (node C) transmits to the target (node A) another NOTIFY command requesting a notice on the change in relation to the status X (Step S33). Upon reception of this command, the target (node A), which no longer has available memory for a cue, sends a TIMECUT TIME response, informing that the notice requested by the NOTIFY command will not be made due to a cue overflow (Step S34). This response includes time information indicating the amount of time remaining for the node D before timeout. Therefore, the second controller (node C) can predict when the NOTIFY command may be accepted.

When the time t₀ has elapsed since the cue of the first controller (node D) was stored in the memory, and the timeout is reached, the stored memory data of the cue is erased, upon which the target (node A) sends to the first controller (node D) a REJECTED response (Step S35), notifying that the NOTIFY command has been voided. This response does not include time information about timeout time.

Further, the second controller (node C) that receives the TIMEOUT TIME response can predict, from the attached time information, when the timeout is reached. Therefore, the second controller (node C) can resend to the target (node A) the NOTIFY command requesting a notice on the change in relation to the status X (Step S36) right after the erasure of the cue memory of the mode D for example, thereby having the NOTIFY command successfully accepted.

When this NOTIFY command is transmitted in Step S36, the node ID of the node C is stored in the available memory area for the cue, and then an INTERIM response confirming the NOTIFY command is sent to the second controller (node C)(Step S37).

If, on the other hand, power supply to the target device is turned off, a REJECTED response indicating that the NOTIFY command is voided is sent to the controller (node C) (Step S38). No timeout information is attached to this response.

As described above, by using a specific response for the cue overflow situation, A receiving device can be informed more specifically of the reason for a voidance when a NOTIFY command is voided, and can take alternative operation quickly.

In the embodiment thus far described, the IRD 100 serves as the target device which is a receiver of the NOTIFY commands. However, similar control can be achieved by other devices serving as the target device. Further, according to the embodiment described above, description is made only for cases in which the NOTIFY command is used for requesting a notice on channel availability or bandwidth availability controlled by the target device. However, whatever status may be a subject of notice as far as the status is of an operation controlled by the target device.

Further, according to the embodiment described above, description is only made for networks interconnected by the IEEE 1394 bus. However, the present invention is also applicable to data transmission between devices interconnected by other types of network, which not only include a network provided by direct physical connection by means of signal wire lines but also include a network provided by a wireless communications link through which devices perform mutual data transmission.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What we claim is:

1. A method of controlling communications, in a network capable of allowing a plurality of communications devices to perform mutual data communication, the method comprising:
a step of sending a first command from a first communications device to a second communications device in the network, thereby giving instruction for notifying to the first communications device on a predefined status change performed under control of the second communications device;
a step of notifying from the second communications device to the first communications device on the predefined status change if the status change has taken place within a predetermined time period measured from a time of reception of the first command; and
a step of not notifying on the predefined status change if the status change takes place after the predetermined time period.

2. The method of controlling communications according to claim 1, further comprising a step of transmitting from the second communications device to the first communications device, information about the predetermined time period as a response, upon reception of the first command.

3. The method of controlling communications according to claim 1, further comprising a step of transmitting from the second communications device to a third of the communications devices, upon reception from the third communications device of a second command including instruction for notifying on the predefined status change, information about the predetermined time period as a response to the second command, if the second command is received before elapse of the predetermined time period measured from the time of reception of the first command by the second communications device, and if the second communications device is unable to notify to the third communications device on the predefined status change.

4. The method of controlling communications according to claim 1, further comprising a step of transmitting from the second communications device to the first communications device, information indicating that a timeout has reached, upon elapse of the predetermined time period measured from the time of reception of the first command.

5. The method of controlling communications according to claim 4, further comprising a step of transmitting from the second communications device to the first communications device, information indicating that a timeout has reached, before the elapse of the predetermined time period measured from the time of reception of the first command, if the second communications device becomes unable to notify on the predefined status change.

6. The method of controlling communications according to claim 1, wherein the predefined status change is a status change in use of a bandwidth or a channel controlled by the second communications device.

7. The method of controlling communications according to claim 1, wherein the first communications device sends to the second communications device a command that extends the predetermined time period, before or after the elapse of the predetermined time.

8. A communications system comprising a plurality of communications devices interconnected by a network for mutual data communication, wherein a first communications devices connected with the network includes:
a command generating means which generates a command to be sent to another of the communications devices in the network, the command including instruction for having the another communications device notify on a predefined status change controlled thereby;
a first communications means which transmits the command generated by the command generating means onto the network and receives a notice from the recipient of the command; and
a first controlling means which discerns on the notice received by the first communications device;
a second communications devices connected with the network including:
a second communications means which receives the command from the first communications device and transmits a notice to the sender of the command;
a second controlling means which discerns whether or not the predetermined status change specified in the command has taken place during a predetermined time period measured from a time of the reception of the command by the second communications device; and
a notice generating means which generates a notice to be transmitted from the second communications means when the second controlling means has detected the predefined status change.

9. The communications system according to claim 8, wherein the second communications device further includes a response generating means which generates a response including information about the predetermined time period, upon reception of the command by the second communications means, the second communications device transmitting the response generated by the response generating means from the second communications means to the first communications device.

10. The communications system according to claim 9, wherein the response generating means generates a response including the information about the predetermined time period and informing of inability to issue the notice, if the second communications means receives another of the command including instruction for notifying the predefined status change, from another of the communications devices after the transmission of the response to the first communications device but before elapse of the predetermined time period.

11. The communications system according to claim 8, wherein the second communications device sends to the first communications device, information indicating that a timeout has reached, upon discerning by the second controlling means of elapse of the predetermined time period.

12. The communications system according to claim 11, wherein the second controlling means sends from the second communications means to the first communications device, information indicating that a timeout has reached, also upon discerning of a situation which disables to notify the first communications device on the predefined status change before the elapse of the predetermined time period.

13. The communications system according to claim 8, wherein the predefined status change discerned by the second controlling means of the second communications device is a status change in use of a bandwidth or a channel controlled by the second communications means.

14. The communications system according to claim 8, wherein the first controlling means of the first communications device has the command generating means generate a command for extending the predetermined time period, and sends this command from the first communications means to the second communications device, before or after the elapse of the predetermined time.

15. A communications device which is connected with a network provided by a predetermined transmission path and is capable of performing data communication with another of the communications device in the network, the device comprising:
a communications means which receives a command from the other communications device in the network and transmits a notice to the sender of the command;
a controlling means which discerns whether or not a predetermined status change specified in the command has taken place during a predetermined time period measured from a time of reception of the command by the communications means; and
a notice generating means which generates a notice to be transmitted from the communications means if the controlling means has detected the predefined status change before elapse of the predetermined time period.

16. The communications device according to claim 15, further comprising a response generating means which generates a response including information about the predetermined time period, upon reception of the command by the communications means, the communications device transmitting the response generated by the response generating means from the communications means to the other communications device.

17. The communications device according to claim 16, wherein the response generating means generates and transmits from the communications means a response including information about the predetermined time period and informing of inability to issue the notice, if the communications means receives from still another of the communications device still another of the command including instruction for notifying the predefined status change, after the transmission of the response to the other communications device but before elapse of the predetermined time period.

18. The communications device according to claim 15, wherein the communications means sends to the other communications device information indicating that a timeout has reached, upon discerning by the controlling means of elapse of the predetermined time period.

19. The communications device according to claim 18, wherein the controlling means sends from the communications means to the other communications device, information indicating that a timeout has reached, also upon discerning of a situation which disables to notify the other communications device on the predefined status change before the elapse of the predetermined time period.

20. The communications device according to claim 15, wherein the predefined status change discerned by the controlling means is a status change in use of a bandwidth or a channel on the network.

21. A communications device which is connected with a network provided by a predetermined transmission path and is capable of performing data communication with another of the communications device in the network, the device comprising:
a command generating means which generates a command including instruction for having the other communications device in the network notify on a predefined status change controlled thereby;
a communications means which transmits the command generated by the command generating means onto the network and receives a notice from the recipient of the command; and
a controlling means which discerns on the notice received by the communications means for information about an effective period of time for which the notice on the status change will be made, and if the information is found, has the command generating means generate a command for extending the effective period, and has the communications means transmit the command, before or after elapse of the predetermined time period.
